(19) United States
(12) Patent Application Publication
(10) Pub. No.: US 2018/0361253 A1
(43) Pub. Date: Dec. 20, 2018

(54) METHOD OF AUTOMATING SEGMENTATION OF USERS OF GAME OR ONLINE SERVICE WITH LIMITED A PRIORI KNOWLEDGE

(71) Applicant: Scientific Revenue, Inc., San Mateo, CA (US)

(72) Inventor: William Grosso, San Mateo, CA (US)

(21) Appl. No.: 15/983,472

(22) Filed: May 18, 2018

Related U.S. Application Data
(60) Provisional application No. 62/509,564, filed on May 22, 2017.

(51) Int. Cl. A63F 13/792; G06Q 20/08; A63F 13/67

(52) U.S. Cl. CPC A63F 13/792; G06Q 20/085; A63F 2300/205; A63F 2300/558; A63F 13/67

(57) ABSTRACT

Methods are described for rapidly determining characteristics of a group of users of a game or online service that may be useful to predict purchasing or other behavior of those users relative to that game or service even before those users have logged significant hours playing the game or using the service. These methods permit optimization of pricing of goods such as virtual currency or services offered for different categories of players or users.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

The present invention is in the field of automated dynamic yield management optimization in online commerce. More particularly, it presents a method for dividing a population of users of an online game or service into a number of logical segments for analysis and optimization, methods for automatically determining which segments are useful for such optimization, and methods for using those segments to automatically improve the performance of the game or service.

Dynamic yield management—that is, changing parameters such as prices at different times or in different markets or for different customers—has historically been primarily the province of large-scale businesses such as airlines, cruises, hotels, etc., and those businesses have generally sold tangible goods and services.

Online commerce differs from the world of traditional commerce in a variety of significant ways. One important difference is that online sellers may be able to sell digital and other virtual goods. Virtual goods are non-physical objects and currencies purchased for use in online communities or online games. Digital goods may be a broader category including digital books, audio and video programming and the like.

Another important difference is that the online seller of goods, especially in the world of mobile devices, is likely to have vastly greater knowledge about individual shoppers than will be possessed by a bricks-and-mortar seller such as, for example, a department store in a shopping mall. A retail store can run sales (Memorial Day Sale, Inventory Clearance Sale, etc.), but in general rapid movement of pricing in that environment is both difficult and likely to generate ill will from customers. In part this is the case because it is relatively easy for customers to compare not just the prices charged by one retailer relative to another, but by a given retailer over time. Another advantage for sellers of virtual and digital goods is that in general they do not have natural expiration or “sell-by” dates: unlike seats on an airplane or newspapers or bread or a night in a hotel room, they have virtually infinite shelf life, and can be “manufactured” virtually instantaneously.

Even if a bricks-and-mortar retailer is able to rapidly change prices, it is extremely difficult to tailor those prices to individual customers based on their ability/willingness to pay. If a grocer uses a price gun (or a shelf tag) to lower the price of all of the cans of tomato soup on the shelf, the lower price applies to all the inventory on the shelf, and the grocer is expected to honor that price for every customer. In order to increase sales (and increase utility in economic terms), sellers of many online goods and service may be able to lower prices for individual customers who might otherwise feel unable to purchase those goods at the original price.

Particularly in the case of virtual goods, a seller such as a purveyor of online games or an entertainment company selling video or audio content will enjoy many more degrees of freedom. If, for example, a game provider wishes to offer players a virtual currency of “gold coins” that can be used only within the game but is bought with hard currency (e.g., US dollars), the game provider has total freedom to price the coins as it wishes, and can do so based on in-game context (for example, a “health potion” that extends the life of a virtual persona is worth more when the player is about to die). But making the gold coins too expensive will likely discourage many potential buyers, thus reducing revenue; making them too inexpensive leaves money on the table and might even devalue the virtual currency and impair the perceived value of the entire game in the eyes of the players.

Another important distinction between online commerce contexts such as online games on the one hand and most brick-and-mortar contexts is that the average transaction in virtual online commerce is usually small relative to the purchase of an airline ticket. But there may be a larger number of such small transactions, including serial purchases from individual consumers, which may take the form of “impulse purchases”

Another important distinction between online commerce contexts such as online games on the one hand and most brick-and-mortar contexts is that the provider of an online game or service is likely to have (or wish to create) a long-term commercial relationship with users, and thus be motivated to take care to price virtual goods so as to encourage repeat purchases. Airlines and other traditional vendors might also desire long-term relationships, but are generally unwilling to sacrifice short-term gain in order to build them.

Another important distinction is the ready availability of large quantities of data about actual and potential customers—data that can give a seller tremendous insights into the preferences, habits and behavior of those people. For the vast majority of online users, and particularly in the case of users of mobile devices such as smart phones, websites and mobile applications are able to collect information that can give a savvy seller useful insight into the likely behavior of actual and potential customers. That information can be absolute—that is, details about a specific user that is valuable even in the absence of information about other users, or it can be relative—that is, meaningful because it compares a given user to others.

Games and other digital entertainment applications are fundamentally different, and predictive analysis is still crude particularly with respect to lifecycle analysis and churn prediction. Core ideas can be translated to the gaming industry, such as utilizing an increased role for A/B testing to compensate for a current lack of theoretical models or utilizing machine learning (which has progressed a lot in recent years). Utilizing existing “general purpose” infrastructure such as cloud-based technologies can reduce technological complexity.

Digital entertainment applications are generally not exploring this, instead focusing on dealing with technological shifts (e.g., the move to mobile devices), platform shifts (frequent game console and platform releases/updates), behavioral shifts (players tending away from or toward certain genres or gameplay elements), the emergence of virtual reality, smart televisions, and the like, and basic product or sales management concerns. Analytics are often an afterthought at large game companies, or are out of reach of smaller studios or independent developers.

Service companies aren't solving these concerns, being instead focused on discovery and retention (which are themselves core concerns for game companies), whereas monetization companies focus on advertising.

What is needed is a solution that offers a unified system for reporting, analysis, and administration of price optimization, and that should be scalable to accommodate a wide variety of potential use cases or infrastructures so as to facilitate solutions for a wide user base.

### SUMMARY OF THE INVENTION

Accordingly, the inventor has conceived and reduced to practice, in a preferred embodiment of the invention, a system and method or providing a unified, scalable, and user-friendly system and methods for reporting, analysis, and automation of yield optimization with minimal a priori knowledge of the characteristics of the game or application and its users.

More specifically, the subject invention may be used to begin improving yield with minimal delay after initial use with applications such as mobile games. One such method involves evaluating a plurality of attributes of a plurality of existing users of said online game; using said plurality of attributes to divide said plurality of existing users into a plurality of segments; identifying at least a segment of said plurality of said users that is correlated with high performance in at least a category of user behavior relative to other subsets of users; identifying at least a segment of said plurality of said users that has previously been correlated with low performance in at least a category of user behavior relative to other subsets of users; setting a lower bound for a value presented in at least a slot of the paywall; downwardly adjusting at least said value in said slot in said paywall for said virtual goods presented to said segment of said plurality of said users that has previously been correlated with low performance; evaluating the performance of said segment of said plurality of said users that has previously been correlated with low performance by comparing its performance after said adjustment to the performance of said segment of said plurality of said users that is correlated with high performance; and continuing to adjust and compare as provided above until either (i) the performance of the segment of users that had previously been correlated with low performance is roughly equivalent to the performance of the segment correlated with high performance or (ii) said lower bound has been reached.

The subject invention can also be used to automatically determine whether and when to present information, which may include but is not limited to prices for virtual goods, to users in contexts other than paywalls. The subject invention can also be used to automatically determine whether and when to present targeted advertisements to users of online applications including but not limited to games where the timing, context and contents of said advertisements are at least in part determined by the activities of the user within the application. The subject invention can also be used to automatically determine whether and when to alter prices offered to specific users of an online application or service based upon behavioral and other clues that indicate a probability that a user is losing interest in or is likely to discontinue using the application or service. The subject invention can also be used to automatically determine whether and when to present targeted offers to former users of an online application or service, and to determine appropriate terms for such targeted offers.

### BRIEF DESCRIPTION OF THE DRAWINGS

The accompanying drawings illustrate several embodiments of aspects of the subject invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device to be used by an administrator of the subject invention, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for yield optimization, according to a preferred embodiment of the invention.

FIG. 6 is a method diagram illustrating an exemplary method for yield optimization, according to one embodiment of the invention.

FIG. 7 is a method flow diagram illustrating an exemplary method for segment-based optimization according to a preferred embodiment of the invention.

FIG. 8 is a high-level block diagram of the logical relationship between the applications on an end-device and the yield management server according to a preferred embodiment of the invention.

FIG. 9 is a flowchart illustrating the steps involved in an exemplary process for collecting segmenting data regarding a user of a hypothetical mobile game.

FIG. 10 is a flowchart for an exemplary process for determining the value of a specific advertising source and/or strategy, and using that information to adjust how an advertising budget is allocated.

FIG. 11 is a flowchart illustrating a series of steps involved in an exemplary approach to applying tests to a specific segment.

FIG. 12 is a flowchart illustrating the steps involved in applying one of these tests comprising an exemplary version of the subject invention to two segments.

FIG. 13A through 13I illustrate a table representing hypothetical values for a selected sample of possible user segments and attributes.

FIG. 14 is a flowchart illustrating a series of steps involved in an exemplary approach to determining whether a user segment is correlated with a desirable attribute.

FIG. 15 is a flowchart illustrating a series of steps involved in an exemplary approach to increasing yield through automated segment optimization.

FIG. 16 is a flowchart illustrating a series of steps involved in an exemplary approach to increasing yield through automated segment optimization when certain characteristics are known about users prior to user segmentation.

FIG. 17 is a flowchart illustrating a series of steps involved in an exemplary approach to increasing yield through automated segment optimization by adjusting pricing for a user segment to improve its performance relative to another user segment.

FIG. 18 is a flowchart illustrating the steps involved in an exemplary approach to automatically adjusting a paywall to account for wealth effects.

FIG. 19 is a flowchart illustrating the steps used in one example of a process to deliver messaging to players of an online game in which changes to paywall values may automatically trigger such messaging.

FIG. 20 is a flowchart illustrating the steps used in one example of a process to alter non-price aspects of an application such as an online game.

### DETAILED DESCRIPTION OF THE PREFERRED EMBODIMENT

Applications, including both web-based and those that run natively on a device, and including but not limited to games played on mobile devices, may include pages or other graphic presentations that display multiple items that the web application offers for sale to users of the game or other application. The form in which an application presents a list of items available for purchase, together with the prices for those items is generally referred to herein as a paywall.

According to a preferred embodiment of the invention, an automated dynamic yield optimization system comprising an application server that may provide a web application where e-commerce managers may define segments and pricing policies, a web server that may provide a web-based (such as may be accessible via a web browser on a computing device) interface for interacting with the application server as well as a web-based interface where clients may query for pricing policies (such as an online storefront or gaming paywall), a reporting server that may compute aggregate statistics on segments, a segment definition server that computes segment definitions, and an administration server that may contextualize segment metrics for use in reporting operations, is disclosed. Central to all of these is the definition of a “segment”. In order to make the system loosely coupled, and to make it as flexible as possible, the idea of a segment may be defined in terms of a functional language-that is, there is a set of functions, which implicitly take a user as their argument. These are then compared to well-known values, and the results of those comparisons are combined with Boolean operators to yield a truth value (e.g. whether the user is in the segment). This document describes various segmenting functions that may be present according to the invention, and how they may be combined. It does not define the precise syntax of the language, but for the avoidance of doubt, a lisp-like language would be more than sufficient. For example, (=(7_day_time_series(3_day_moving_average number_of_transactions_gold)) MONOTONE_UP) may represent an assertion that a given user's 3 day moving average on their number of transactions has been increasing for the past 7 days. Note that all moving averages are inherently anchored NOW and projected skybackwards, but the operation of creating a time-series anchors in preceding days.

According to the embodiment, an administration server may be utilized such as to contextualize or normalize metrics reported such as with per-capita, relative, or distribution measurements. Metrics often are recorded as raw numerical data such as “minutes played” being reported in a single active session. When contextualized, this metric data may become, for example, “minutes played per day”, or additionally contextualized for a particular segment. Metrics reported might include a variety of relevant or desirable summary, demographic, revenue, spending, virtual currency, engagement, retention, gameplay, or churn metrics. Such metrics may be reported over time, facilitating use according to a variety of potential administrative actions such as those described above.

From within a report, a user may use an administration tool to make changes and edit information, effecting a blended reporting and administration system. As envisioned, the system of the invention may be adaptable to mobile system architectures and implementations as well as larger, more traditional environments such as desktop computer workstations.

“Wallet-engagement” may be measured according to the invention. A person can play a free-to-play game indefinitely without spending; there are various useful measures of engagement: Is she playing? Acquiring skills? Is she bringing other people on/acting social? Is she interacting with the economy? Ideally, the answers to the other these questions will be correlated; to the extent they're not, an imbalance in the game is thereby identified. If she is playing a lot and spending a lot, but not acquiring skills, she is a churn risk (game is too hard). If she's acquiring skills abnormally quickly, she's a churn risk (game is too easy). If she's playing a lot and acquiring skills, but not spending money, she may have become a long-term freeloader we would like to convert. Such correlations and metrics may become apparent via the reporting and administration functions provided by the system of the invention, as described previously. Spend metrics may also be measured according to the invention, for example by measuring customer lifetime value, traditional payment-wall metrics such as non-engagement with the payment wall, the payment wall's impact on engagement, or take-rates on various aspects of the payment wall.

As previously described, the invention may utilize the notion of a “segment”, referring to a user or group of users. “User” may refer to any individual or group using an electronic service or product. The invention may comprise a set of “canned segments”, or preprogrammed sample or dummy segments such as for testing or analysis purposes. Additionally, there may be a means for retiring or recycling segments, effectively updating any sample data or logic within a system. Such canned segments may be generated automatically, may be customizable for specific implementations or for particular users, and may have a set timeframe for data collection and reporting, and may have pricing rules or data associated with them as with a “real” segment, i.e., a human customer.

Regarding segments, the subject invention can include several basic operations. Such operations may include but are not limited to:
Examine segment—this consists of selecting a segment and viewing a wide range of metrics associated with it
Compare a segment today with a past version of itself—given a segment, a user of the subject invention may view data for now and for an arbitrary past timeframe. Such a timeframe may be an absolute date (e.g., data from June 1), a relative date (data from previous three weeks), or other implementations such as configurable time-markers.
Compare multiple segments—similar to comparing against past version, but comparing current data for a plurality of different segments
Compare multiple segments across time—combining previous actions, view data for multiple segments across a timeframe
Restrict report—control who may view what data
Export data—the ability to export report data to other formats

The ability to evaluate and act upon the observed intersection between semantically distinct segments yields potentially powerful results. For example, the ability to segment users of an online game or other service who view a pricelist or paywall the first time they play the game or use the service is likely to indicate which users are interested in making a purchase, but tells the seller very little about their ability to do so. Segmenting users based on indicia of affluence is likely to indicate which users have a high ability to purchase, but little about their desire to do so. But the intersection of these two segments—that is, the segment of users who manifest markers of both intent and ability to spend—is likely to be a fruitful group to target, and the ability to automatically identify and target them will be very useful.

According to a further embodiment of the invention, a client administration server may be used for managing various aspects of a client's program or service. According to the embodiment, the invention may provide such features as merchant services (such as order processing, pricing, or delivery), identity services (such as user or session tracking), game mechanics (such as A/B testing, rewards management, or fraud control), messaging (such as control of form and function of standardized messages such as “thank you” e-mails, or push-based messages or events such as alerts sent to offline users), or a “ledger” service for currency control (that may not be accessible to the public directly, and that may be used similarly for both real-world and virtual currencies). Currency support may comprise a full-featured, cloud-based “wallet”, or optionally the ability to give clients currency administration such as for creation of internal virtual currencies as may be desirable. Additionally, the invention may utilize repudiation handling and wallet updates, such as optionally utilizing push-based wallet updates to ensure synchronicity and validity between wallets if a dispute or discrepancy arises.

According to the embodiment, a client administration server may utilize open-source or other existing frameworks or elements such as for ease of integration with existing components that may already be in use (initial cost to a potential client, both in terms of monetary investment as well as infrastructure concerns). Administration may comprise such features as multi-tenancy and security models (user accounts, administrative access control), or the ability to view various read-only information such as user data (such as names, contact information, non-editable history, or other such information that may be identifiable with users), pricing rules (further described below), policy definitions, segment definitions, and optionally the ability to synchronize data (such as for backup, version control, or synchronicity between multiple copies of similar data), such as is common in the art with cloud-based synchronization or data storage solutions.

An adaptive pricing library may be utilized. For example, a mobile device may operate a software library in communication with remote servers, such as to manage a payment wall for customers. Such a payment wall may present tailored offers or pricing based on previously reported user data, such as might optimize revenue and “cash-in” while reducing dissatisfaction or churn. Such an adaptive model may be scalable to other industries according to the invention, for example whenever a user makes a purchase of intellectual property (such as a software license or a copy of a movie), they may be charged the optimal price. Such an approach may be appropriate for a variety of industries and media, such as television content or newspaper articles.

Adaptive pricing may be further scalable or adaptable, expanding to include virtual currencies. Game players and the game industry are shifting to a focus on immersive games with rich content catalogs. An appropriate adaptive pricing embodiment may comprise payment wall optimization, in-game point-of-sale (POS) optimization, web-based storefront optimization (such as for Amazon™ or other web-based vendor fronts), or mobile storefront optimization such as for tablet or smartphone app purchases.

It can be appreciated from the above that the invention may take the approach of “closing the loop” between reporting and report-based actions and thus automating such processes. This may utilize such approaches as detailed user models, user/segment-specific pricing policies, or reports demonstrating outcomes and suggesting additional actions or improvements.

There is value to the provider of online services, virtual or other digital goods, games, etc. in understanding its customers. Among other things, (improved user experience, etc.) that knowledge can be used to increase revenue by helping the provider to adjust pricing so as to maximize the number of customers who buy/play, maximize the time (and money) customers spend using the service or playing the game, etc.

Traditional microeconomics takes what must in this context be seen as an overly simplistic view of the pricing problem. It has largely continued to discuss the same two-dimensional demand and supply curves that have been taught in introductory economics classes for at least fifty years. This model asserts that customers will buy more of a good at a lower price, and less at a higher price.

While still superficially appealing, this simple model depends upon multiple simplifying assumptions, many of which are unlikely to apply in contexts such as online commerce and virtual or other digital goods. Those assumptions include, but are not limited to:
(a) Single-unit sales, or at least that there are no discounts for volume purchases. If the price of a good depends on how much of that good is purchased by a given consumer, there is not a single demand curve.
(b) No bundling of purchases with other goods. Again, if a consumer faces different prices for the same quantity of good A depending upon whether the purchase is combined with a purchase of good B, there is no single demand curve.
(c) Rational, linear demand function. As will be discussed further below, in practice the demand for most goods (at least for consumer goods) is non-linear in some fairly predictable ways. There will generally be discontinuities, for example, between the demand for a good priced at $0.99 and the same good priced at $1.00.
(d) Temporal and behavioral independence. A consumer's willingness to buy one of good A at a price of $0.99 today is assumed not to have “hysteresis”; that is, it is assumed not to really matter whether the consumer bought good A (or good B) yesterday. In fact, consumers are creatures of habit, and yesterday's purchases significantly affect price sensitivity today. Furthermore, in the case of goods like virtual currencies or other consumables in an online game, availability of a given good is likely to affect the way in which the player interacts with the game, and in effect trains them to play the game in reliance on the availability of that good, thereby increasing the odds that the player will be willing to pay to obtain it.
(e) Absence of “relativistic effects”. As will be discussed in greater detail below, when a customer is presented with multiple pricing options, as in the case of an online paywall, with multiple price per unit options, it is theoretically possible to claim that the those options in effect define a demand curve, but it is probably more correct to say that the consumer in fact has multiple demand curves, and that the interaction triggered by the paywall is more complex.
(f) Insensitivity to social cueing. A perfectly rational consumer will not be swayed by the shape of another consumer's demand curve. Thus a seller would not be able to affect a perfectly rational consumer's willingness to buy at a given price by pointing out that one slot on a paywall is more popular than another, for example. In fact, such cueing can be quite powerful for some buyers.
(g) Single-stage decision-making. The traditional model assumes that a consumer confronted by multiple offers to sell a good (whether from multiple sellers or from a single seller) will calculate the price per good, her need for the good, etc. and choose accordingly. Again, as will be discussed in greater detail below, it is asserted that consumers often make purchase decisions using a multi-stage decision-making process, and that the complexity of that process is not easily reduced to a single demand curve.
(h) Negotiability. The traditional model assumes that in general goods are freely transferable (though there are some exceptions, such as airline tickets). Transferability creates arbitrage opportunities, which in turn limit the ability of sellers to vary pricing.

Perhaps the most widely discussed traditional market that has featured yield optimization is the market for air travel. It is widely understood that the price of a ticket to fly in coach class from New York to Los Angeles varies dramatically depending up on how far in advance it is purchased, when the flight is scheduled, etc. Airlines have learned fairly well how to optimize in that context. However, yield optimization for mobile content differs in a number of fundamental respects.

Whereas airlines tend to price tickets based on factors that reflect the behavior of at least a broad cross-section of its customers, sellers of virtual or other digital goods to mobile customers can engage in iterative 1:1 optimization—that is, a seller can offer user 123 a virtual or other digital good at price X, but follow that offer up later with an offer at X-y whether or not it chooses to do so for user 456.

While airlines could have chosen to strongly differentiate their services on non-pecuniary factors, in fact few do so, at least for coach travel. But sellers of virtual goods such as virtual currency can easily differentiate their offerings in various ways, not least because virtual currency from one game cannot usually be spent in a different game. And sellers are free to create an infinite variety of new goods to offer: virtual weapons or armor in a combat game, clothing and jewelry in a dress-up application, etc.

Although airlines may wish it were not so, numerous websites offer consumers the ability to easily discover and compare the offerings of multiple carriers for essentially the same offering. There are currently no comparison shopping sites for virtual gold coins in games for mobile devices, which frees sellers to offer lower prices to consumers who would not buy at higher prices.

Sites like Expedia.com and Orbitz.com exist in large part because most airline tickets cost hundreds of dollars or more, and because they represent a significant purchase for many consumers. Thus investing time in effort in price discovery and comparison-shopping is often seen as appropriate and worthwhile. As the success of vendors like Starbucks demonstrates, people tend to be less price-sensitive for frequent, small purchases. So sellers of services and virtual or other digital goods to users of mobile devices, which may cost significantly less than a dollar each, can assume that they have some freedom to iterate pricing to discover consumer preferences.

Perhaps the largest difference between the two contexts is that the number of seats on a given airplane is effectively fixed, and airline strategies are to some degree driven by that scarcity. But the supply of virtual armor, virtual gold coins, a given piece of software, or a specific video or audio recording is effectively infinite, which is likely to drive a very different approach to yield optimization.

Another significant difference is that airline seats are, in effect, a perishable good: once the cabin doors close in preparation for departure, unsold seats effectively expire unconsumed. But a virtual gold coin is both evergreen and need not be “manufactured” until it is needed; there need be no spoilage.

For example, a mobile game may be made available for download and play to users in many countries. Those different countries are likely to have not just different currencies, but different cultures, different levels of affluence, and so on. As a first approximation, a game provider might simply translate the price for a virtual or other digital good from its initial market (say, USA) to a second market (say India) using exchange rates alone. Thus a $0.99 U.S. price might be translated to a 65 rupee price in India. This automatic conversion is likely to result in psychologically “unfriendly” prices—that is, prices that do not take into effect basic principles about (currency-independent) effects driving how people tend to read and understand prices. But there are many other reasons why such first-order approaches might be suboptimal. For example, many Americans will perceive a $0.99 purchase as trivial and easily affordable; there may be tens or hundreds of millions of potential users in India for whom spending 65 rupees is not trivial.

For sellers of most physical goods (e.g., smart phones), a major component of the price paid by a consumer consists of the cost to produce the product—materials, tooling, labor, etc. But for most virtual and other digital goods, such as currency within a game, or digital entertainment such as music or video programming, the cost to produce the product is essentially zero. (There may be related costs for hosting, etc., but the marginal cost of a single virtual coin is likely to be too small to accurately measure.) Thus roughly 100% of the revenue generated through sale of the virtual or other digital good is also gross profit. This has important implications for how a seller can approach the pricing of these goods. The seller does not have to charge the same (dollar-denominated) price in all countries, or even to all people within the same geographic area. It can determine the maximizing price country-by-country or another basis. If a price of 6.5 rupees for a virtual or other digital good generates 100× the number of purchases that are generated by the 65 rupee price, the lower price increases the seller's revenue by an order of magnitude, as well as its gross profit.

Such differential pricing has been applied in the world of physical goods. But it can create numerous difficulties for a seller because it can lead to arbitrage opportunities. If a smart phone manufacturer sold a device for $500 in the US and sold the same device for $250 in India, a grey market of devices from India would quickly appear in the US, undermining the seller's strategy. Sellers of digital goods and services, on the other hand, may have the ability to control or prevent transfers of virtual goods, thereby curtailing or eliminating the opportunity for arbitrage.

Virtual or other digital goods that are associated to networked electronic devices create numerous potential advantages for sellers. Not only is it difficult or impossible to arbitrage price differences, it may be difficult (though not impossible) to even discover them. Furthermore, sellers often have access to considerable knowledge about customers. For example, in general the provider of a smartphone-based game may know the country in which a player is located, as well as her location on a much more granular level, her cellular provider, the make, model and operating system of the device she is using, and many other facts about a given user. These factors can permit a game provider to offer lower prices in some markets and higher prices in others. But what are the optimal prices? Will presenting lower prices increase the odds that a given user will purchase them? Will presenting a lower price lead to more purchases in the future, thus increasing the lifetime value of the customer to the provider? Arbitrary price-setting may increase in-app purchases and thus revenue . . . or not. It would be advantageous to be able to adjust prices based on controlled testing that leverages modern statistical techniques and predictive analytics in order to automatically process and identify key features, behaviors and characteristics that help identify and predict outcomes including monetization patterns, and to automatically optimize pricing over time based on learning.

While geography is likely to be an important determinant of the optimal price for a given virtual or other digital good, it is not the only one. Providers of virtual or other digital goods such as in-game currencies or software may have access to data that indicates to the provider numerous clues regarding the likely behavior of a given user including:
Whether the user is engaged with the game or service;
The degree to which the user is engaged with the game or service;
Whether the user's pattern of engagement predicts long-term retention'
How recently the user downloaded the game/application;
and many other factors.

It may be true that one or more of these factors is a strong predictor of the future purchasing preferences and behavior of individual users. But it is very unlikely that a game or service provider will have the data (or the analytical capabilities) to determine which factors are most meaningful for purposes of determining optimal pricing strategies.

It would be advantageous to arrive at differentiated prices empirically, through evaluation of statistical correlation of various observable factors, such as those listed above, with the desired result (generally, increased long-term revenue per user).

Techniques for determining optimal prices over time have been described in U.S. application Ser. No. 14/252,497, and PCT applications US14/59559, US14/59564 and US14/59571. Those processes are effective in optimizing pricing once the most powerful differentiating factors have been identified. But identifying the key factors that best predict the future purchasing preferences and behavior of individual users generally requires considerable experimentation, testing of behavioral models, etc. Thus developing that insight has been prohibitively expensive for many game and software providers. The long timelines involved even for those who might be able to undertake such an analytical process has cost them valuable time, revenue, and the resources needed to perform such analyses, including the energy needed to power the computers employed in pursuit of that knowledge.

It would be advantageous to provide a method for identifying key factors that best predict the future purchasing preferences and behavior of individual users quickly and automatically.

The inventor has conceived, and reduced to practice, a system and method or providing a unified, scalable, and user-friendly system and methods for reporting, analysis, and subsequent administration of yield optimization, as well as methods for rapidly establishing useful segmentation strategies for populations of users or customers when a priori knowledge of the characteristics of those users is limited or absent.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

A “segment”, as used herein, refers to a real or simulated human user or group of users, such as may interact with or operate electronic devices or services. Such segments may be the subject of price optimization or other operations, several exemplary types of which are described below.

A “canned” segment, as used herein, refers to preprogrammed sample or dummy segments such as for testing or analysis purposes, such simulated segments ideally operating and behaving in a manner as closely simulating real human users as possible.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

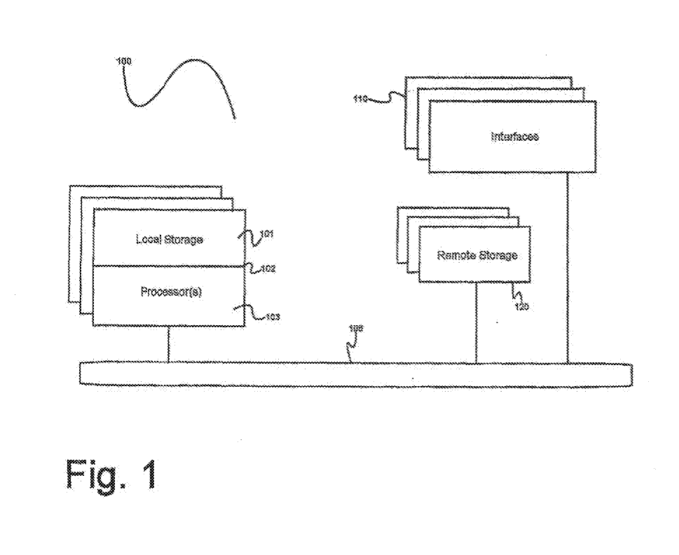

FIG. 1 shows a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

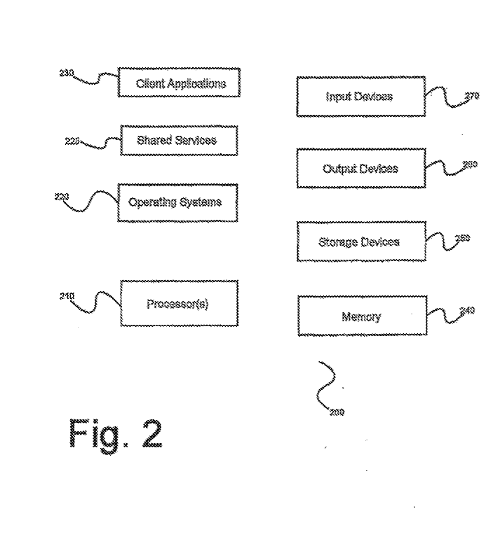

In some embodiments, systems according to the present invention may be implemented on a standalone computing system. FIG. 2 shows a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

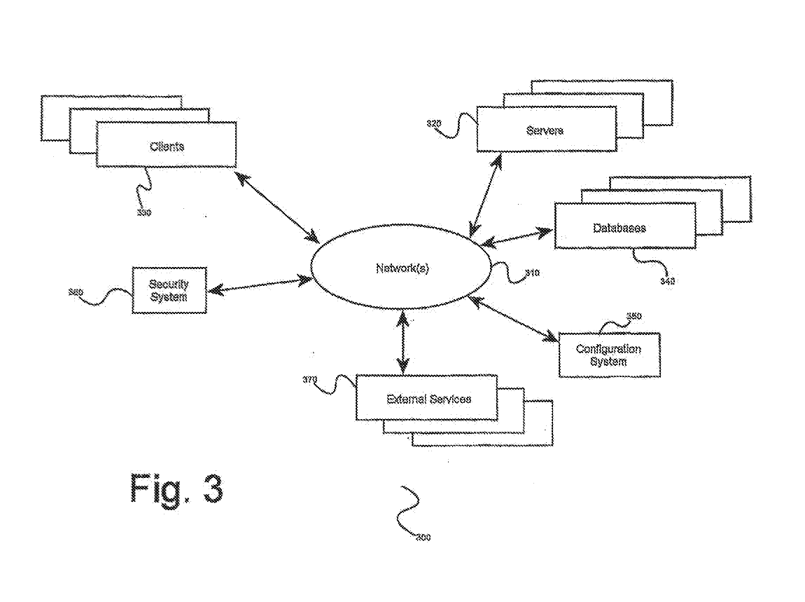

In some embodiments, systems of the present invention may be implemented on a distributed computing network, such as one having any number of clients and/or servers. FIG. 3 shows a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

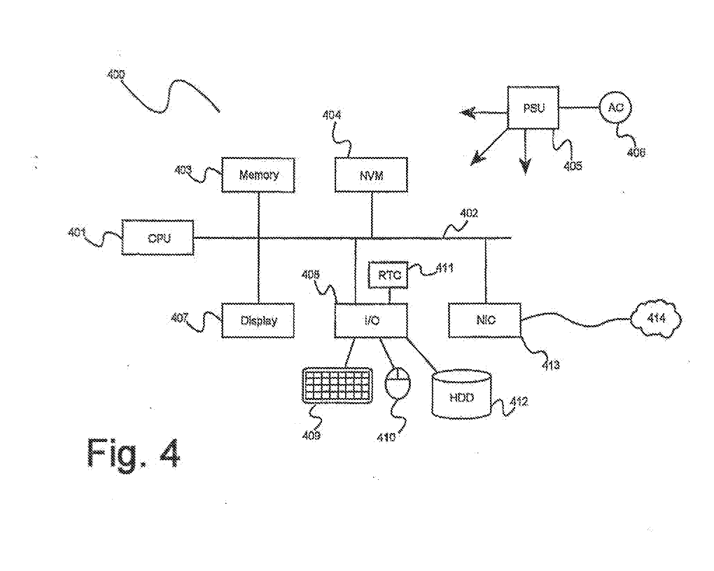

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

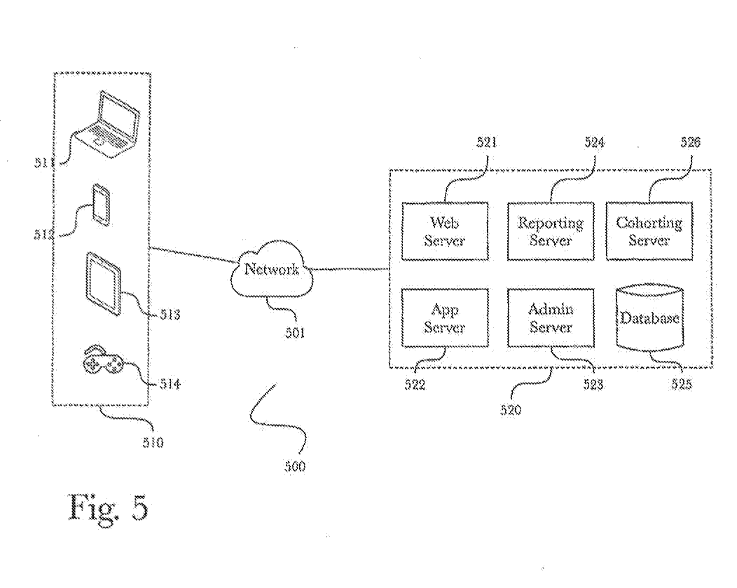

FIG. 5 is a block diagram illustrating an exemplary system architecture 500 for dynamic yield management according to one embodiment of the invention. As illustrated, various traditional components of a computing network may be interconnected and in communication via the Internet 501 or a similar data communications network. It should be appreciated by one having ordinary skill in the art, that such an arrangement is exemplary and a variety of connection and communication means exist which may be utilized according to the invention, and it should be further appreciated that various combinations of connections and communication means may be utilized simultaneously or interchangeably according to the invention.

As illustrated, a plurality of users 510 may interact with an automated yield management system 520 across a network 501 via a variety of hardware or software means common in the art, several examples of which are illustrated. It should be appreciated that such means as illustrated and described below are exemplary, and any of a variety of additional or alternate means may be utilized according to the invention. Hardware means may include (but are not limited to) electronic devices capable of communication over a network 501, such as a personal computer 511 (such as a laptop or desktop computer), mobile smartphone 512, a tablet computing device 513, or a video gaming console 514 (or other such dedicated gaming hardware, for example a handheld gaming device or an integrated home PC designed or utilized for gaming purposes, such as an OUYA™ or STEAM MACHINE™ device). As appropriate and according to the specific nature of a device being utilized, users 510 may interact using a variety of software means (not illustrated), such as a web browser accessing a webpage or other internet-enabled software (as may be appropriate when using a personal computer 511), or a mobile application (as may be appropriate when using a mobile smartphone 512 or tablet computing device 513). It should be appreciated that, as with physical devices described above, such means as described are exemplary and a variety of additional or alternate means may be utilized according to the invention. It should be further appreciated that such devices and means may communicate via multiple networks 501, either simultaneously (such as multi-band or MIMO configurations for wireless data communication) or interchangeably (such as a mobile smartphone with multiple radios for communication across a variety of protocols or frequencies).

As further illustrated, users 510 may communicate via a network 501 such as the Internet or other appropriate communication network, for such purposes as interaction with an automated yield management system 520, various components of which may be similarly connected to a network 501 for communication, and which may also be interconnected within system 520 for communication with other components. Such components may include (but are not limited to) a web server 521 that may operate web-accessible content such as webpages or interfaces for viewing by users and also may receive web interactions from users (such as an interactive administration interface for viewing reports or taking report-based actions, as described below), an application server 522 that may operate various software elements for interaction such as via web-enabled means operated by web server 521 (such as an interactive reporting application, as described below and such as might be interactive via an interface presented by a web server 521 as described above), a database 523 or similar data storage component that may store data from other components as well as provide such stored data for interaction (such as for viewing or modifying existing or historical reporting data, or storing segment information such as definitions as described below), a reporting server 524 that may create or manage electronic reports, and an administration server 525 that may provide administration functions for user interaction (such as controlling or managing other components or features of system 520). It should be appreciated that internal components of a system 520 such as a reporting server 524 or administration server 525 may be directly accessible for user interaction (such as when a server operates its own interaction interface, as is common in the art with other computer applications) or indirectly via an interface or application operated by another component such as a web server 521 or app server 522, either simultaneously or interchangeably as appropriate according to the invention. For example, it is common in the art for a single software component such as an administration application stored and operating on a computing device such as an administration server 525 to be accessible via multiple means according to a user's preference or the nature of the desired interaction. For example, an integrated interface may be provided by an administration server 525 for basic interaction such as viewing the operational status of the server, while more complex interaction may be provided by a separate interface operated by a web server 521, allowing users a choice of interaction means.

As illustrated, a segmenting server 526 may be utilized for such purposes as to process, manage, and otherwise control segment definitions. For example, user account management for a game-based arrangement might be handled by a segmenting server 526, such as to define attributes of user accounts (groups of which may be considered segments according to the invention), metrics by which segments are measured, scored, or reported, or any other such segment-related functions. Additionally, segmenting server 526 may receive input from other components such as an administration server 525 for such purposes as to modify behavior or to alter specific segments, for example when a user wishes to alter the status of a user account or change the way in which certain metrics are tracked or reported. In this manner, a segmenting server 526 can be appreciated to serve multiple internal functions that are accessible to other components as needed.

As illustrated, reporting server 524 may be connected to and in communication with other components such as app server 522 such as to provide functionality for interaction via software elements (as may be appropriate for mobile device applications, wherein a user might directly view or interact with generated reports), web server 521 such as to provide functionality for interaction via webpages or similar web-enabled means, or database 523 such as to store and retrieve reports or information relevant to reporting (such as configuration or other criteria for generation of reports). In this manner it can be appreciated that a function of reporting server 524 may be to provide functionality to other components that may operate specific means of interaction, while still optionally providing functionality directly to user applications or devices 510 (as described above), thereby enabling a variety of arrangements and means of interaction according to the invention.

Reporting server 524 may perform reporting functions as described above, such as generating and providing reports of segment definitions, behavior, or interactions, metrics-based reporting as described below, or other various reporting functions that may be appropriate according to a particular use case according to the invention. It should also be appreciated that the functions provided by reporting server 524 may operate independently of additional components, such as in an arrangement that simply produces reports for use in an external system not part of the invention. For example, a reporting service for yield optimization may produce reports and provide them to an external or third-party product or service for presentation to, consumption by, or interaction from a user, such as a software-as-a-service (SaaS) or cloud-based use case. It should therefore be appreciated that additional components such as database 523 or app server 522 may be utilized as needed in various configurations according to the invention, and the arrangement illustrated is exemplary and by no means the only possible arrangement and that alternate arrangements such as might incorporate more, fewer, or alternate components may be possible according to the invention.

As further illustrated, administration server 525 may be connected and in communication with other components in a manner similar to that described above for reporting server 524, such as being connected to app server 522 such as to provide functionality for direct interaction via software elements (such as, again, in a mobile device application wherein a user might perform functions directly via an application interface), web server 521 such as to provide functionality for interaction via webpages or similar web-enabled means, and database 523 such as to store and retrieve information relevant to administration functions or operations (such as, for example, a user's stored preferences or historical administration operations). In this manner it can be appreciated that a function of administration server 525 may be to provide functionality to other components that may operate specific means of interaction, while still optionally providing functionality directly to user applications or devices 510, thereby enabling a variety of arrangements and means of interaction according to the invention. It should be appreciated that, as described above with relation to a reporting server 524, an administration server 525 may operate independently of other components as appropriate, such as to provide administration functions to a user while utilizing external or third-party solutions for other functions described herein, such as report generation or web interaction. In this manner, an administration server 525 may operate in a SaaS or cloud-based manner according to the nature of a specific arrangement, and various alternate arrangements may be possible according to the invention.

Administration server 525 may contextualize or normalize metrics reported such as (for example) with per-capita, relative, or distribution measurements. Metrics in the art often are recorded as raw numerical data such as “minutes played” being reported in a single active electronic game session. When contextualized, this metric data may become, for example, “minutes played per day”, or additionally contextualized for a particular segment. Metrics reported might include a variety of relevant or desirable summary, demographic, revenue, spending, virtual currency, engagement, retention, gameplay, or churn metrics. Such metrics may be reported over time, facilitating use according to a variety of potential administrative actions such as those described above. Contextualized metrics may then be provided to reporting server 524 for use in reporting operations, such as to provide a user with detailed contextualized information on segments (for example, “this player has played x minutes per day” or “players who spend y per hour of gameplay are less likely to churn”, or other such contextualized metric-based information).

Administration server 525 may utilize open-source or other existing frameworks or elements such as for ease of integration with existing components that may already be in use (thereby lowering initial cost to a potential client, both in terms of monetary investment as well as infrastructure concerns). Administration may comprise such features as multi-tenancy and security models (user accounts, administrative access control), or the ability to view various read-only information such as user data (such as names, contact information, non-editable history, or other such information that may be identifiable with users), pricing rules, policy definitions, segment definitions, and optionally the ability to synchronize data (such as for backup, version control, or synchronicity between multiple copies of similar data), such as is common in the art with cloud-based synchronization or data storage solutions.

It should be appreciated by one having ordinary skill in the art that the specific nature of a reporting server 524 or administration server 525 may vary according to the invention, such as optionally incorporating or utilizing open-source or third-party elements as are common in the art. It should be further appreciated that the interconnected and accessible nature of components of the system 520 of the invention may be seen as “closing the loop” between reporting and administration, allowing users 510 to perform administration tasks from within a report or in parallel, as may be afforded by a unified application interface (as would be operated by an application server 522) and that as described, the nature and function of system 520 may be adaptable to a variety of hardware architectures such as including (but not limited to) mobile computing devices (such as tablet computing devices or smartphones) or traditional desktop or server computer workstations. It should be further appreciated that various components of system 520 need not be physically collocated-that is, the specific nature of their interconnections and means of communications may vary according to the invention, such as direct cable or wired connections as may be appropriate for components located in close physical proximity (such as servers or similar computer hardware operating within the same physical location) or via network-based connections as may be appropriate for components operating in separate physical locations, effecting a distributed architecture. It should be further appreciated that certain components as described above may operate in a standalone, SaaS, or cloud-based manner, and it is the functions provided by these components that is relevant to the invention as described and claimed herein, and various alternate or additional arrangements of components utilizing various alternative components in place of or in addition to those described may be possible according to the invention.

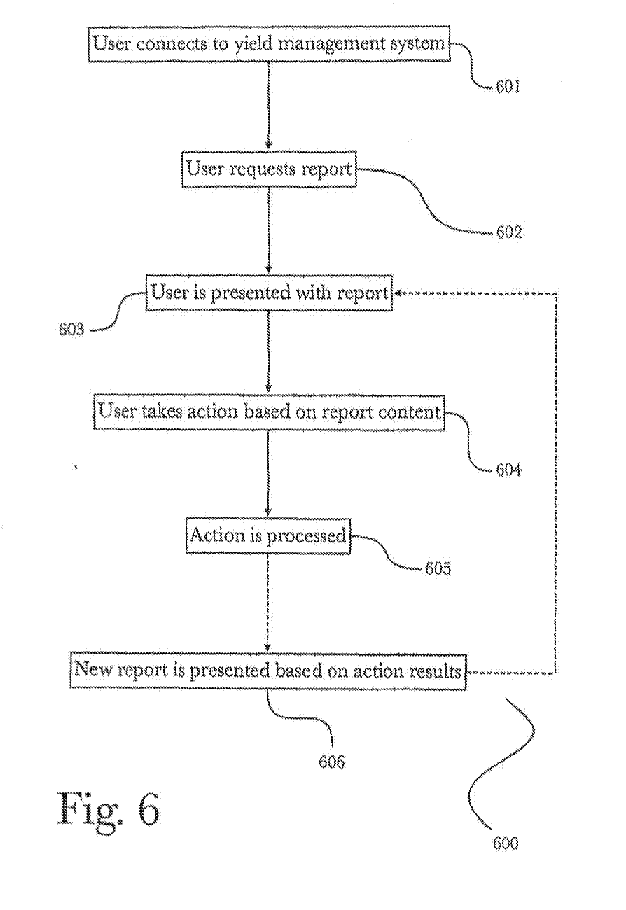

FIG. 6 is a method diagram illustrating an exemplary method 600 by which a user managing the yield management service might interact with the system of the invention (as described above, referring to FIG. 5) such as to view a report and then take actions based upon information viewed, according to a preferred embodiment of the invention. As illustrated, the method described is from the perspective of a user interacting with the system of the invention for yield optimization, to illustrate the practical benefits offered as currently envisioned by the inventor.

In an initial step 601, a user may connect to a pricing optimization system via any of a variety of means according to their intended purpose, such as via a web interface or web-enabled application for viewing reports on a mobile computing device such as a smartphone (or other network-connected device). Such interaction means may be provided interchangeably or simultaneously by various components of a pricing optimization system as described above, such as a reporting server providing a reporting interface directly to a connected user, or a web server providing a web-based interface for users to access from their devices as needed, or other such arrangements.

In a next step 602, a user may request (such as by browsing through a menu and making a selection, or by submitting search query, or other such means of navigating information via a computing device) reporting information. Such information may be viewed “live”, or as it is being generated, such as when a user may wish to monitor current operations, or it may be retrieved as needed from a storage such as a database, to provide a user with prior or historical data for review. In a next step 603, the user may be presented with the reporting information, optionally including various interactive elements or means for taking actions form within the report, such as modifying rules or metrics that may be contained within or related to content of the report. In this manner, a user may be presented with options for both content consumption (reading the report) and actionable means relevant to the requested content, within a single unified interface and optionally without any explicit request or action (or even knowledge) on the part of the user—that is, actionable content may be presented automatically regardless of the user's request, such that a user may be proactively provided with options that may be useful to them (rather than leaving it to the user to decide what actions they may want to take, and then seeking out a tool or means for taking those actions).

In a next step 604, a user may take action based on the reported information, such as submitting messages to be sent to other individuals (for example, notifying a player that their account status in a game has been updated based on their reported behavior in the game), modifying rules (such as changing the way in-game currency is exchanged with real-world currency), or modifying metrics that are reported (such as changing the basic content of the report to be more relevant to the user's interests). In a next step 605, the actions are processed (such as by an administration server, as described above), and a user may then request or be automatically provided with updated reporting information in a final step 606, facilitating a closed-loop operation model beginning again at a report viewing step 603. In this manner, it can be appreciated that the invention serves to provide users with a single unified means to view and modify their price optimization operations, and in doing so automated yield optimization is made more accessible to users of varying skill or technical knowledge.

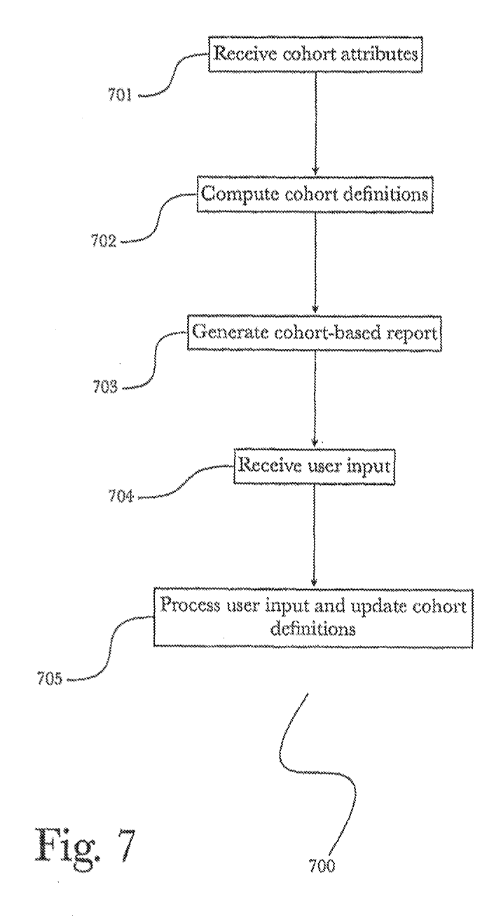

FIG. 7 is a method flow diagram, illustrating an exemplary method 700 for segment-based automated yield optimization, according to an embodiment of the invention (such as might utilize the system described above, referring to FIG. 5). In an initial step 701, a system for automated yield optimization may receive general segment attribute information, such as from a preexisting database (such as when a yield optimization system is being connected to an existing arrangement, such as a gaming network or a business management system) or from connected segments (such as users interacting with a system, for example players in a game or customers in a CRM system). Segment attributes might include, but are not limited to, usernames or identification information, account numbers, quantities of in-game currencies, character skills or other earned attributes, game items, or any other such information that may be considered relevant to a segment in particular or to operation of an automated yield optimization system in general. In a next step 702, a segmenting server may generate segment definitions, such as by associating various attribute information with specific segments (for example, associating a user's in-game items and currency with their username or account number), such that a segment may now be considered to comprise a plurality of information both identifying the segment as well as defining a variety of associates attributes or qualities. In a next step 703, a reporting server may utilize these generated segment definitions to produce segment-based reports, such as by calculating metric-based statistics or other quantifiable reporting output based at least in part on the segment definitions. For example, based on a plurality of segment definitions that include usernames as well as metrics describing each segment's length of time participating in a game (for example), a report might indicate comparative playtimes for each segment, optionally contextualized as described above (referring to FIG. 5) to provide more relevant information such as “hours per day” for each segment. In this manner, it may be seen that by computing and utilizing segment definitions, specific information relevant to dynamic yield optimization may be provided easily, and the use of segment definitions and a segmenting server for computation may also make the contextualization of metrics easier to provide for enhanced automated dynamic yield optimization compared to solutions known in the art.

In a next step 704, a user (such as a yield optimization analyst) may view a generated report, such as to review the current state of segments or the operation of a system in general. A user may then submit input in a next step 705, such as by making selections on an interactive report display, or by interacting with a web-based or other such interactive application for pricing optimization, for example to take action based on the reported information (for example, based on reported revenue-per-hour information, a user might choose to give select segments a “bonus” for their participation). In a final step 706, the user's input may then be processed such as by an administration server, applying any necessary changes and updating segment information as appropriate such that user input may be immediately utilized in future segment computation and reporting functions. In this manner, it may be appreciated that the method described herein offers a “closed-loop” means for a user to view and act upon pricing optimization reports, enabling direct management when appropriate and incorporating any such actions in order to keep segments and reports up to date and relevant. As described below, it is also possible to automated this process so that iterative yield management can operate without requiring that a human operator or analyst manually adjust settings and parameters for each iteration.

In order to develop models that will differentiate users based on meaningful factors that are likely to predict their propensity to spend or other factors, it is necessary to test those factors against the behavior of users of a specific game or service. For each new product, new pricing or other optimization strategy and new customer population, there will be benefit to testing against a variety of factors or segments.

The process for arriving at the most meaningful differentiators is generally iterative. As previously practiced, this process has been slow, difficult and resource-intensive. In order to arrive at an optimal outcome quickly with minimal ongoing involvement of highly skilled (and thus expensive) human data scientists, a system as described herein can automatically progress from a point at which there is little or no knowledge about the most useful bases for segmenting users of a previously un-studied game, service or other electronically delivered product to a point at which useful segments have been identified and tested, and the game or service or other product has deployed dynamically optimized pricing based on those segments.

In one embodiment, the initial phase of the process is to apply a pre-set categorization schema to the user base of the game or service (and to the initial set of prices or other performance factors). Thus initially the users may be placed in segments based on characteristics that include but are not limited to:
Price wall information
Engagement
Intensity of engagement
Retention models
Knowledge regarding other games or applications loaded on the consumer's device
Join date
Time of day (for both when a user downloads the game or application, and when she uses it)
Day of week (for both when a user downloads the game or application, and when she uses it)
Purchase patterns (generally of goods offered within the game or application)
Country in which the user resides or in which the device has been registered with a carrier
Information about the device(s) the user is using including physical characteristics (for example, screen resolution), software characteristics (for example, which version of a particular operating system the device is using), and contextual characteristics (for example: list price, or age)

The relative importance of these factors will vary. For example, for a simple game with minimal learning curve and that takes only a few minutes to play, time of day/day of week are likely to be relatively unimportant; for complex games that take time to learn and complete, they are likely to be much more significant.

Different initial segmenting criteria may be used. While the system described herein will eventually arrive at optimized segments even if the initial segmenting criteria are not optimal, the closer the initial criteria are to optimal, the faster the subject invention may be able to begin maximizing results.

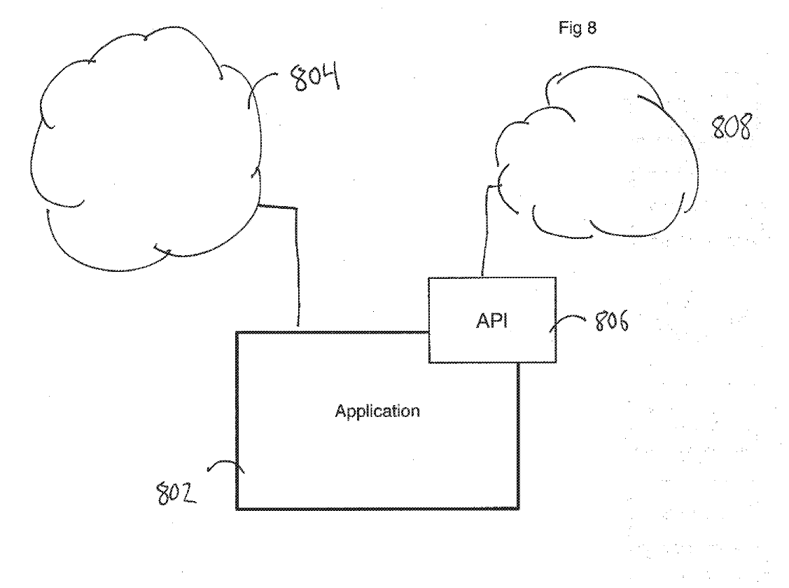

One means of deploying the subject invention involves integrating aspects of the invention into a gaming application deployed onto a mobile device. The yield optimization service may offer a software development kit (SDK) to enable integration of the necessary functionality into a specific mobile gaming environment, as illustrated in FIG. 8. Similar techniques may be employed to employ the subject invention in mobile applications other than games.

Mobile game 802 resides on a mobile device. For numerous functions, game 802 communicates with a cloud-based server or servers 804 operated by the provider of game 802. Such functions may include connecting an individual player with other players in multi-participant games, storing attributes such as a player's accumulated experiences in the game to enable persistent attributes such as skill level, upgrades, etc.

In order to enable dynamic yield optimization, SDK 806 may be integrated into game 802. SDK 806 enables at least two essential functions: it permits the SDK 806 to communicate bi-directionally with game 802, and it permits SDK 806 to communicate with one or more yield optimization servers 808.

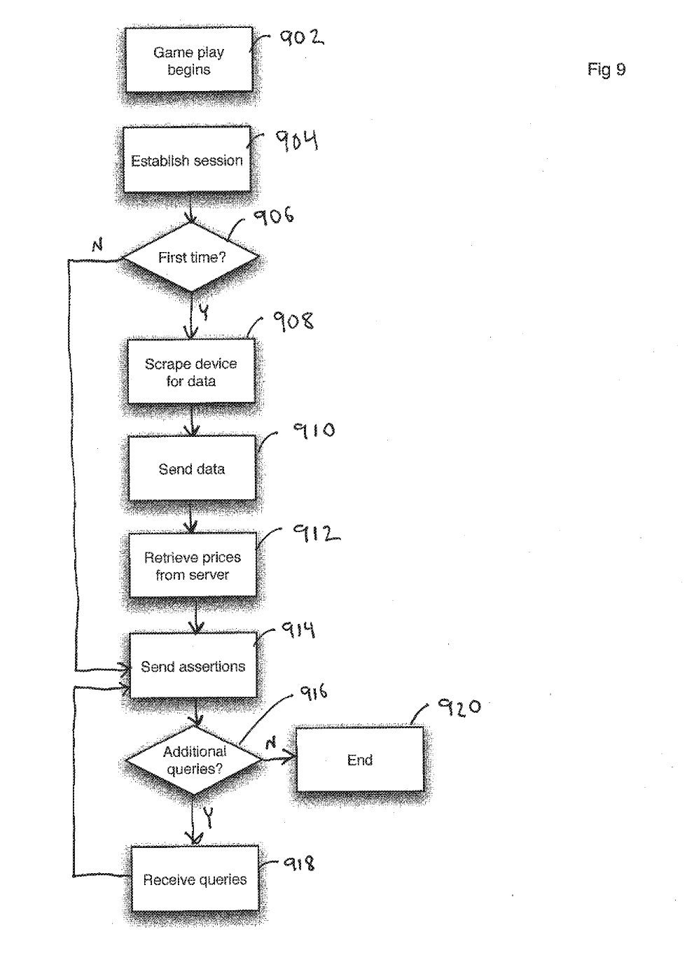

When a game provider has enabled the subject invention, and SDK 806 has been integrated into game 802, SDK 806 acts the first time the individual user begins to play the game, as shown in FIG. 9.

In step 902, the individual user begins playing a game in which the subject invention has been enabled. Code resident in the user's mobile or other device recognizes that game play has been initiated and opens a session with the yield optimization server 808 in step 904. This session permits the exchange of messages and information between the end-user's device (which may be a mobile smartphone 512, a tablet computing device 513 or other connected device) and yield optimization server 904 as needed during and immediately after the conclusion of the game-playing session. Communication is established and maintained using techniques commonly understood in the field.

In step 906, yield optimization server 808 determines whether the particular mobile or other device has previously been logged in to yield optimization server 808. If it has not, then steps 908 through 912 are completed. In step 908, yield optimization server 808 retrieves persistent data about that device. Such information may include factors such as the make and model of the device, the specific cellular network with which it communicates, the operating system and version it uses, the display characteristics (e.g., 720×1280 pixels, 4.8 inch diagonal) and many other characteristics. All current tablets, smart phones and personal computers report numerous attributes to requesting servers that connect via the Internet or cellular networks. Those attributes may include, but are not limited to hardware manufacturer (e.g., Samsung), model (e.g., Galaxy S4), and operating system (e.g., Android 4.4 KitKat). These attributes may be stored as part of the persistent record for each individual device used by a player of a game or application employing the invention

In step 910, the end-user device transmits the requested data to yield optimization server 808. In step 912, yield optimization server 808 transmits initial pricewall values to the end-user device. These pricewall values may be universal default values, or they may be optimized to the extent possible based on the information available to the yield optimization server 808 through initial data scraping as performed in the previous steps.

In step 914, the mobile device sends to yield optimization server 808 various data points (“assertions”) associated with events and states relative to the playing of the game on the device. Such assertions may include items like:
This player just paid X in in-game currency to purchase good Y
This player just viewed the paywall for in-game currency
The “health” of this player within this game has recently decreased (health being an abstracted, non-game-specific quantification of the viability of a persona/role within the game environment)
This player has recently acquired Z experience points in this game or has advanced from level X to level X+1 (specific examples of the general proposition that progress and skill acquisition indicate higher investment in the game on the part of the player, which likely grants greater pricing power to the game provider).

Assertions can be tailored to permit learning relative to other game parameters as well. Considerable additional data may be acquired, including GPS data, internal accelerometer data, internal gyroscope data and other attributes. From these data points, the yield management service provider can infer potentially useful attributes such the list price of the device, the part of the world where it was sold, etc.

In step 916, the yield management server 808 determines whether additional information from the device is useful at that time. If so, in step 918, additional queries are transmitted to the device, which are in turn answered with additional assertions in step 914, and so on. When there are no additional queries, (generally because the playing session has ended) the process stops in step 920.

The steps illustrated in FIG. 9 will be largely the same if the subject invention is enabled in a mobile application other than a game, thought the substance of the assertions and queries will likely be different. However, for virtually any application or transmittable media, information on the device will be available that the subject invention will be able to evaluate for factors that correlate with willingness to purchase additional goods, services or media or other factors that may be meaningful to the provider of the game or other service.

Next, the subject invention records the activities of the customers in terms of the segmenting criteria. Thus, for purposes of illustration, assume that the product being evaluated is a game to be played on a smart phone, and the virtual good to be optimized in the pricing of virtual gold coins currently priced at (a) $1 for 100 coins, (b) $4 for 500 coins, and (c) $7 for $1000 coins.

The subject invention may, for example, record that hypothetical user 1157:
(i) is in Germany, and first played the game at 10:14 AM local time on Aug. 25, 2015, which was a Tuesday;
(ii) played one session of 24 minutes on the first day, two sessions totaling 37 minutes on day 2, not at all on day 3, and three sessions totaling 55 minutes on day on day 4;
(iii) continued playing the game for varying lengths of time for two more weeks; and
(iv) purchased no coins.

This process will be repeated for thousands (ideally, tens or hundreds of thousands) of users.

Once this information has been collected, the subject invention may analyze each of the segments for their predictive power—that is, to determine how well each segment, both individually and potentially in combination with other segments, predicts success (or failure) however it may be defined: often defined as long-term monetary value, but the subject invention is capable of application to a variety of metrics. These can include:
percentage of customers who purchase
average number of days between downloading or registering and purchase
average value of purchase
how long users continue to play/use the product

The subject invention can use the results of this analysis in multiple ways. As described in detail below, it can be used to adjust pricing for in-application purchases of a variety of digital goods including virtual currencies. It can also be used to inform marketing efforts for a service or game. It is well understood in the field that it is possible to determine the referral source of users who come to a web site from specific advertisements. It is therefore also possible treat those advertisement sources as segments, and thus to determine not merely how many users have come from a given ad, but whether those users are profitable, or meet other criteria that are important or meaningful to the success of the game provider or seller of the service or product. If a specific seller of ad space refers many users, but very few of those users become paying customers, a game or application provider may decide that advertising with that seller is a poor allocation of resources, and choose to advertise elsewhere.

In many cases, such advertising is a major source of users and thus revenue for applications such as games. But the process of evaluating the value of a given advertising strategy has historically been very primitive. The subject invention provides buyers of such advertising with a powerful tool for optimizing the productivity of that advertising based upon a range of criteria, and to determine which criteria are most meaningful. It also provides means to automate that process, enabling this optimization to operate at sufficient scale and low enough cost to make it practical for advertisers to evaluate large numbers of advertising opportunities and strategies, even when the dollar value of an individual placement is relatively small.

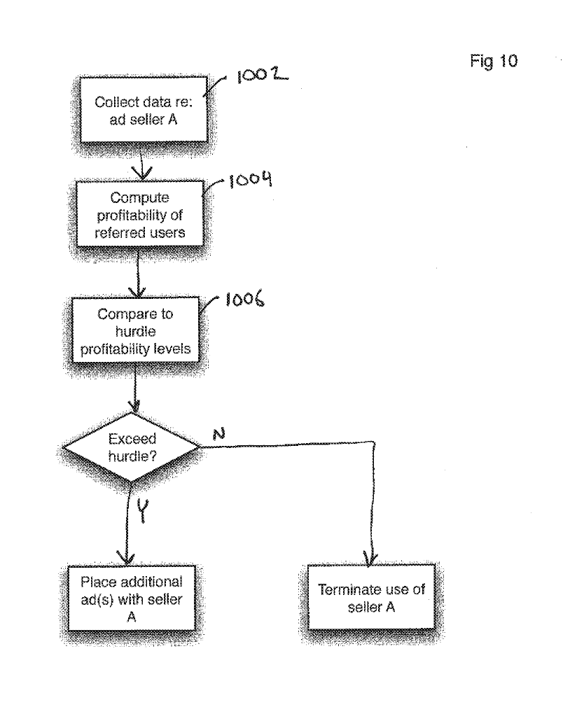

FIG. 10 is a flowchart for a process for determining the value of a specific advertising source and/or strategy, and using that information to adjust how an advertising budget is allocated. In step 1002, the subject invention collects relevant data regarding the performance of a specific advertisement. Such information may include but is not limited to the lifetime value (“LTV”) of the users acquired from that ad, ARPU (average revenue per user), ARPPU, (average revenue per paying user), etc. In step 1004, these attributes are used to compute the value to the game provider of that advertisement.

In step 1006, the results of that analysis are compared to one or more “hurdle” metrics that may be used to inform automated decision-making to maximize the value of advertising investments. Those hurdles can be static (e.g., “does the ad's revenue exceed its cost?) or dynamic (“does the 90-day revenue from this ad exceed the 90-day revenue for the last 3 evaluated ads?” In step 1008, the application determines whether the advertisement clears the hurdle. If it does, the invention initiates the process of placing additional ads such as the one evaluated in step 1010. If not, it terminates such purchases in step 1012.

Another step in the overall process is to apply a diagnostics framework to the previously generated data set. The diagnostics framework is intended to evaluate the initial segmenting categories against a variety of potentially useful economic criteria. Those criteria may include, but are not limited to:
% of users in a given segment who became paying users
% of paying users who bought more than once
% of users who purchased something on the first day of use
% of users who purchased something on or before the 2nd day of use
% of users who viewed a pay wall but did not purchase
average revenue per user (ARPU)
average revenue per paying user (ARPPU)

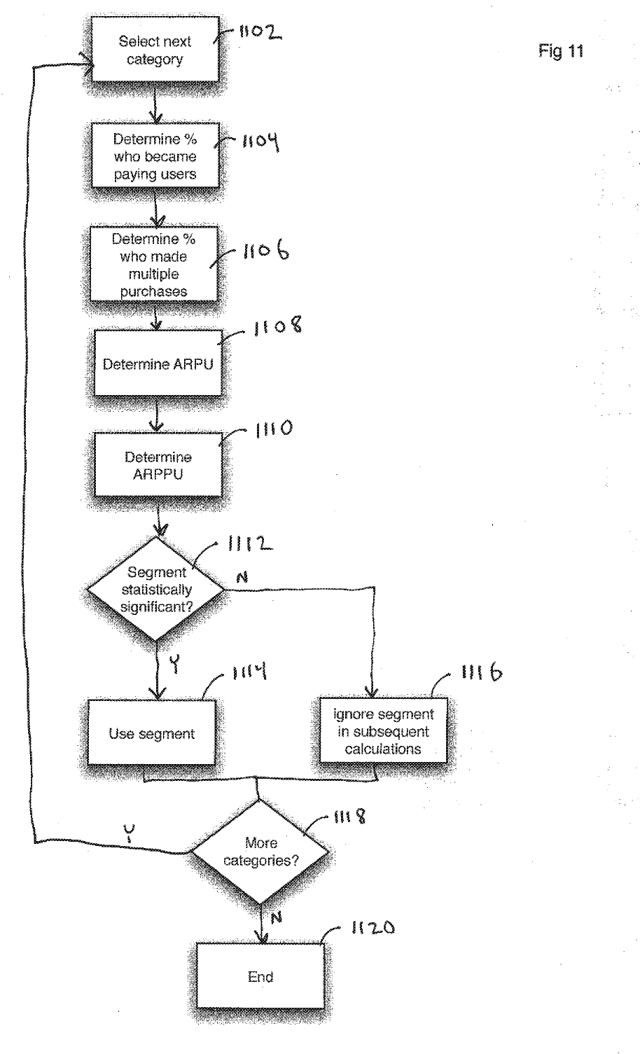

FIG. 11 is a flowchart illustrating a series of steps involved in one approach to applying tests to one of the previously discussed segments. In step 1102, the subject invention chooses a segment for evaluation. The subject invention may automate the process of sequentially evaluating multiple segments, as discussed below. In step 1104, it applies the first of a series of tests to that segment. In the case of step 1104, the test is to determine the percentage of members of that segment that became paying users of a specific game. In step 1106, the percentage of users who made multiple purchases is calculated. In step 1108 the average revenue per user (over a specific duration) is calculated for the segment. In step 1110 the average revenue per paying user is calculated for the segment. Additional or different tests may be applied.

Once the individual calculations for relevant metrics for a specific segment are complete, in step 1112 it is determined whether there is any statistical significance or other value associated with the segment—in other words, whether grouping users according to the specific segmenting criteria yields any useful insights. Even if the result is that the tests show that a given segment is an unusually unattractive audience for a given game, that knowledge can be extremely valuable, and can inform numerous critical decisions, including allocation of marketing budgets, pricing of in-game purchases, and product design. Significance could be shown if, for example, a segment is 40% more likely than the average user to become a paying user, or if average revenue for the segment is 60% lower than average.

If the segment shows value, then in step 1114 the segment is used in subsequent aspects of the invention as discussed below. If value is not shown, then in step 1116 it is ignored.

In step 1118 the invention determines whether there are additional segments to be evaluated. If so, the process repeats; if not, in step 1120 it ends.

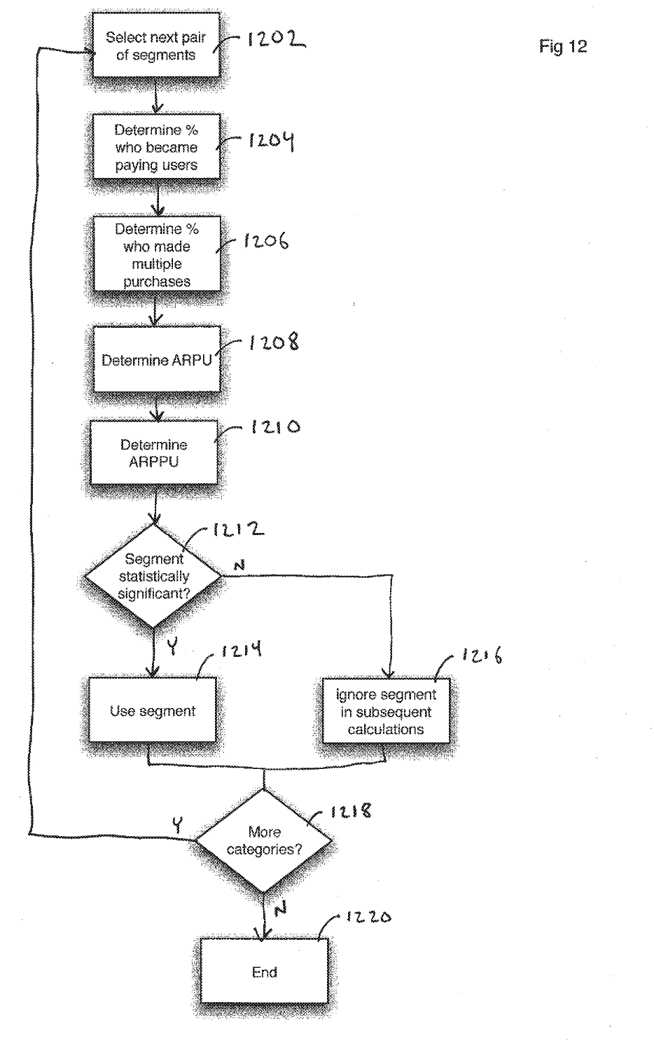

The subject invention may also apply the previously described economic tests to one or more combinations of the previously discussed individual segments. This step may find useful predictors that might not otherwise appear from analysis of single segments alone. For example, the Join Day of Week may not show great predictive power alone, which could also be the case for the Join Time of Day alone. But it may turn out that players who join on Friday afternoons are much more likely to become loyal players than those who join on Monday mornings. Thus Day of Week=Friday for first download alone may show no value; Time of Day=5-6 pm local time alone may show no value. But those two attributes together—i.e., the segment of users who first download the game between 5 and 6 pm on a Friday could turn out to be very meaningful. Thus it will be advantageous to evaluate not just individual segments for significance, but also combinations of segments. FIG. 12 is a flowchart illustrating the steps involved in applying one of these tests to two of the previously discussed segments. Similar processes may be applied to groupings of more than two segmenting criteria.

In step 1202, the subject invention chooses a segment combination for evaluation. In step 1204, it applies the first of a series of tests to that combination. In the case of step 1204, it is to determine the percentage of members of that combined segment that became paying users of the game. In step 1206, the percentage of users in that combined segment who made multiple purchases is calculated. In step 1208 the average revenue per user (over a specific duration) is calculated for the combined segment. In step 1210 the average revenue per paying user is calculated for the combined segment. Additional or different tests may be applied.

Once the individual calculations for relevant metrics for a specific combination are complete, in step 1212 it is determined whether there is any statistical significance or other value associated with the combination—in other words, whether grouping users according to the specific combination of segmenting criteria yields any useful insights.

If the combination of segments delivers meaningful differentiation, then in step 1214 the segment combination is used in subsequent aspects of the invention as discussed below. If no value is shown, then in step 1216 the combination is ignored.

In step 1218 the invention determines whether there are additional segment combinations to be evaluated. If so, the process repeats; if not, in step 1220 it ends.

The analysis as performed in the previous two steps will likely reveal one or more of several important potential results. For example, the analysis could reveal that 45% of users in the US who reach the paywall go on to complete a purchase of gold coins, while only 2% of users in India do so. It could reveal that the ARPPU is 70% higher for users who made their first purchase on the first day of use than for users who did not make their first purchase until at least five days after the first day of use. Or it may reveal that high intensity users who download the game on a Monday have significantly higher ARPU than users who download it on other days of the week. Each of these insights could drive specific adaptations to the pricing and/or marketing strategies applied to the specific product being optimized using the subject invention. So for example, if only 3% of users in Thailand make a purchase after reaching the paywall, the prices used for one or more of the slots in the paywall shown to users in Thailand can be reduced. Or if players who make a purchase within 48 hours of the first day of use show a 300% higher lifetime value than players who do not purchase until later, the game can offer lower paywall prices during the first few days of play and let them gradually rise afterwards.

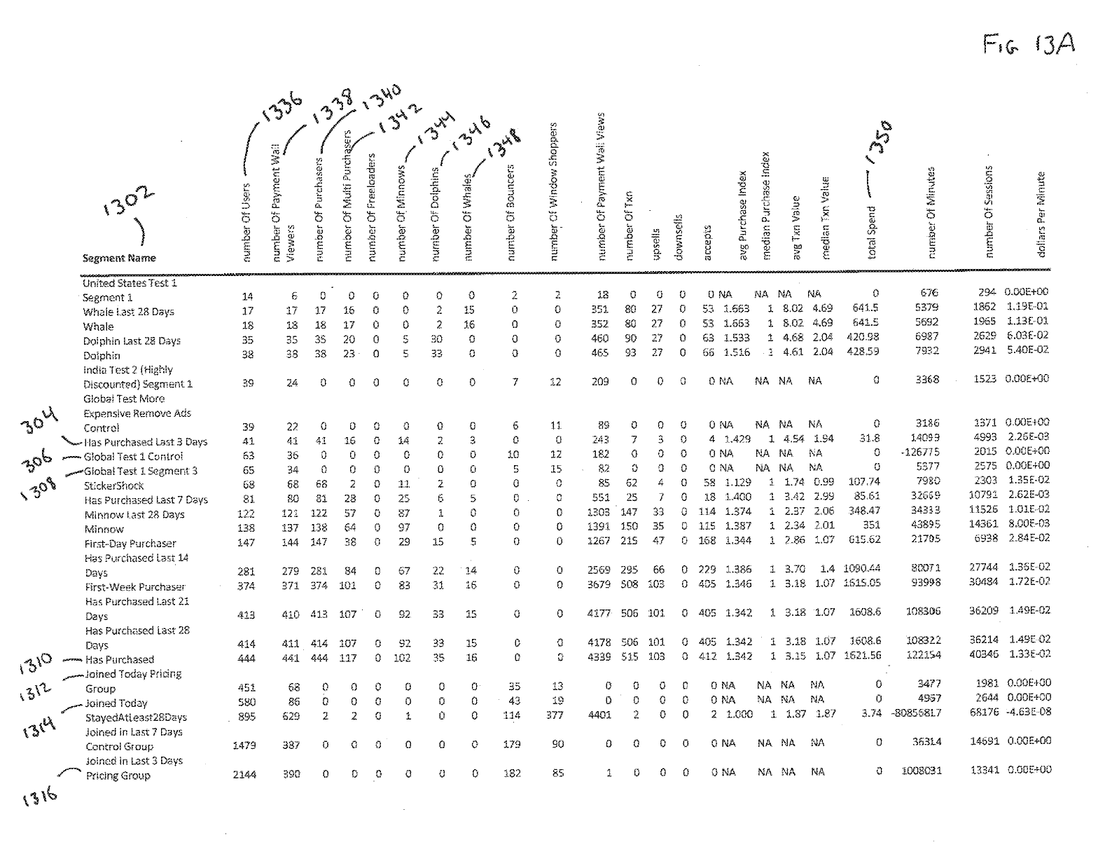

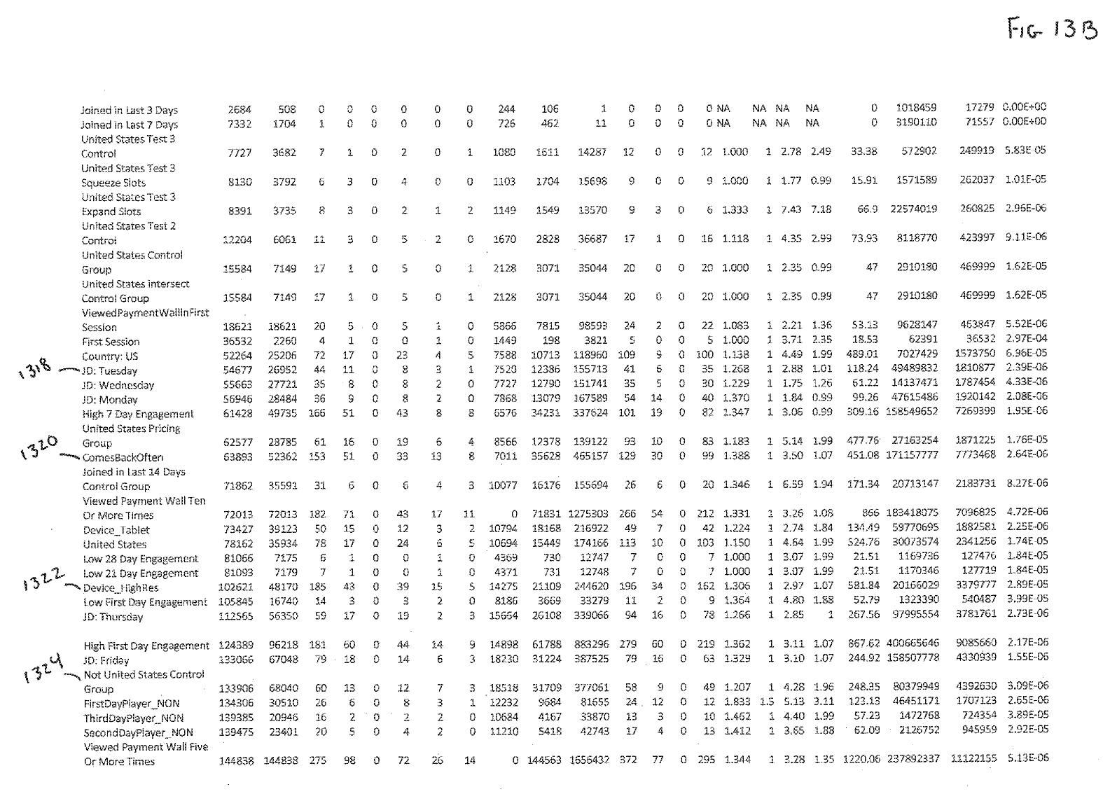

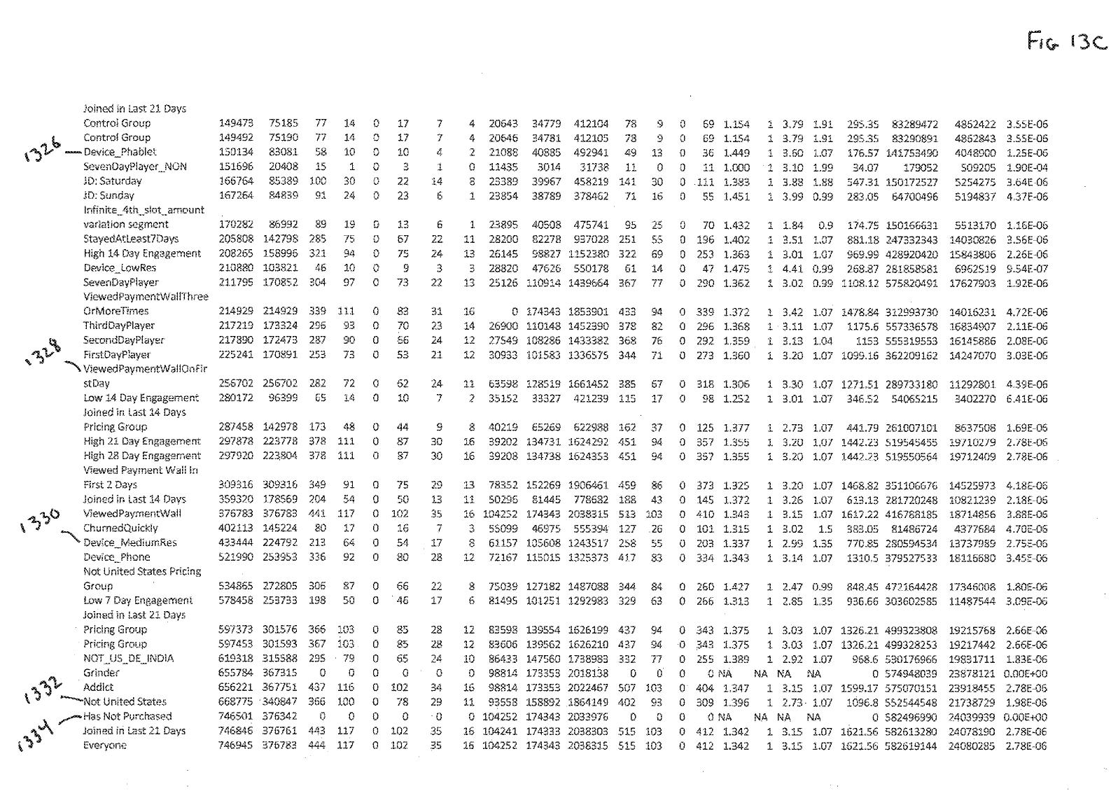

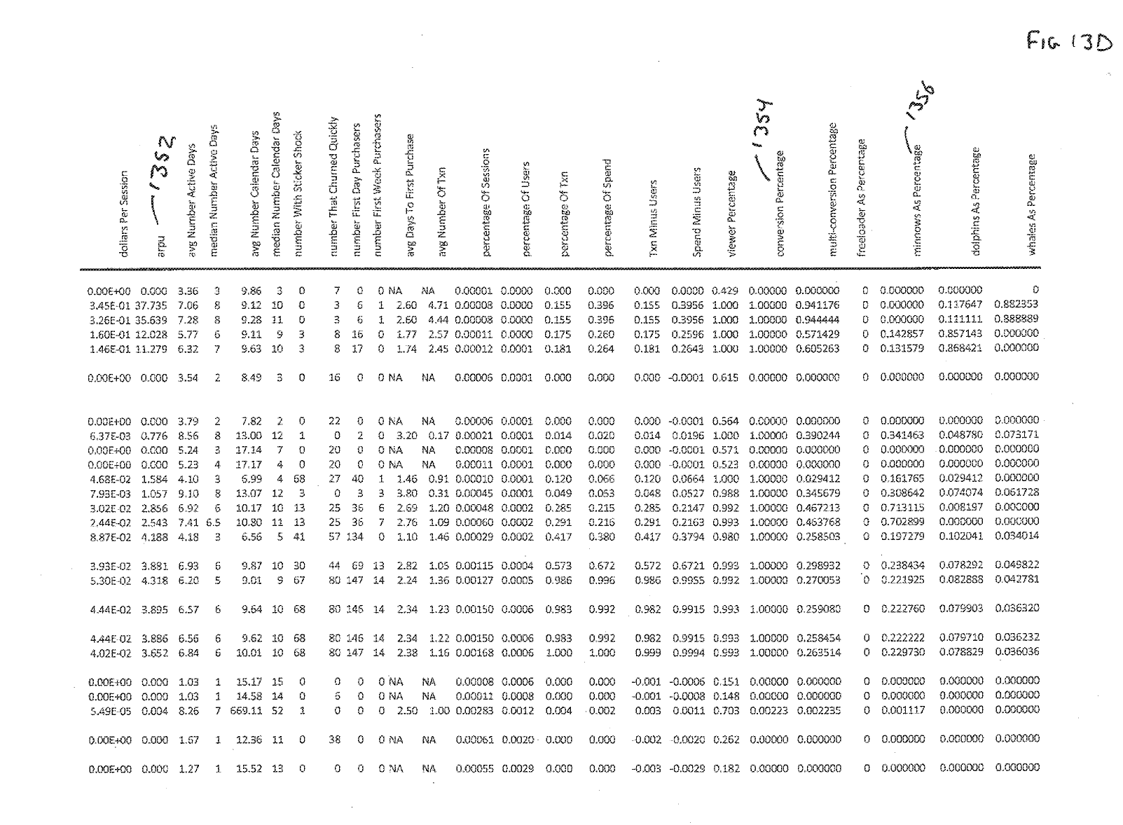

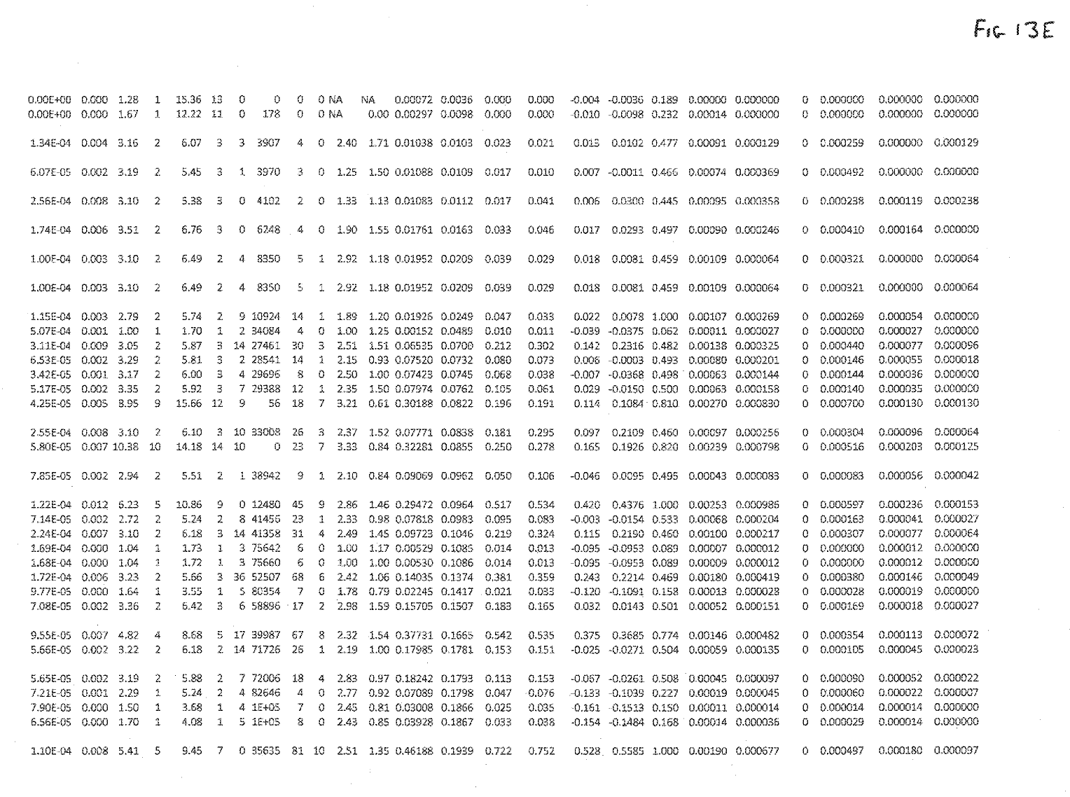

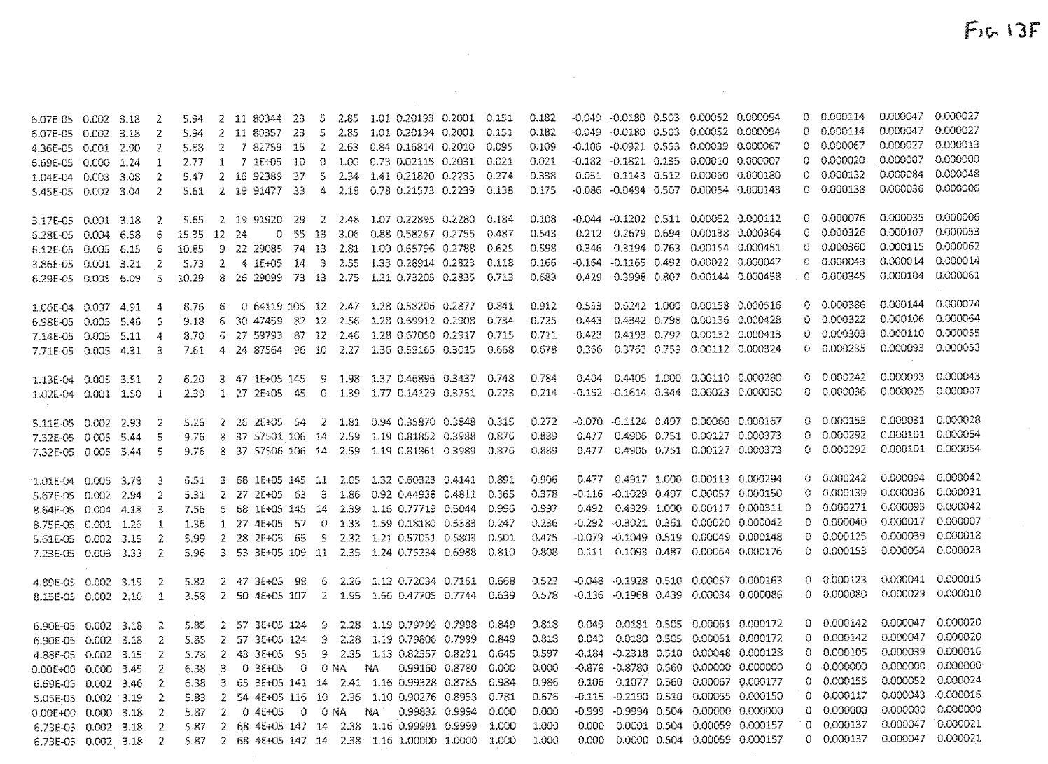

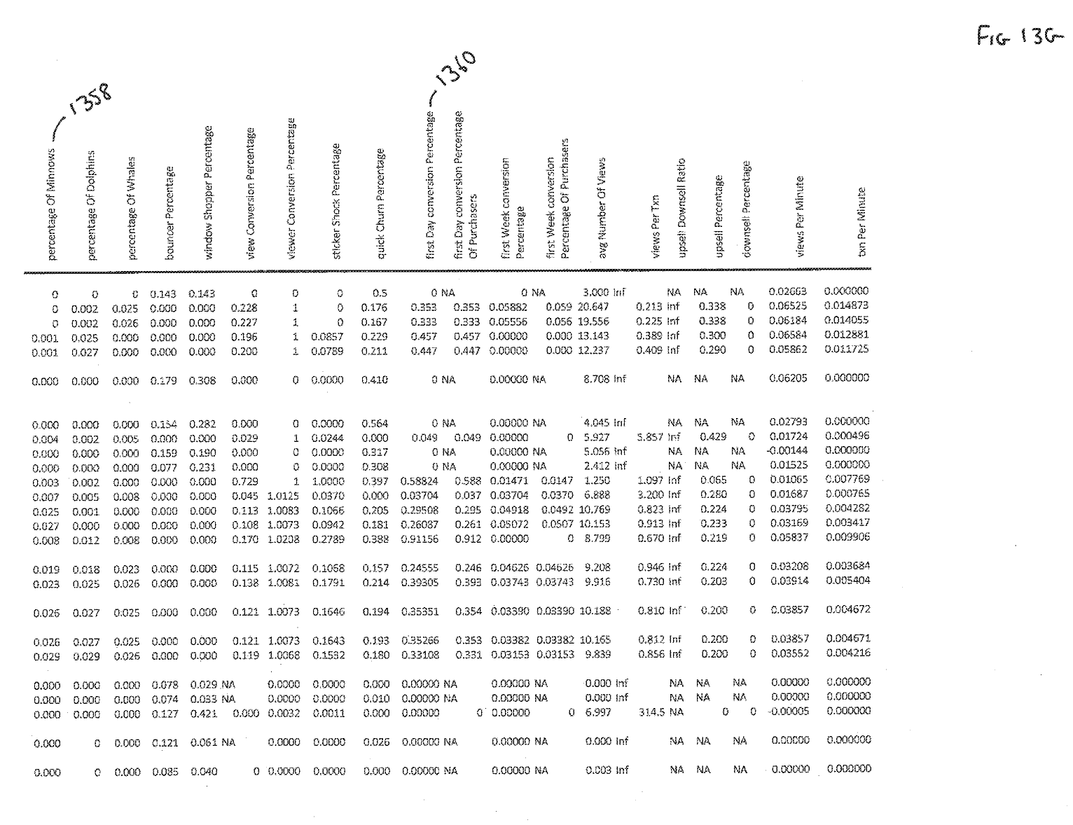

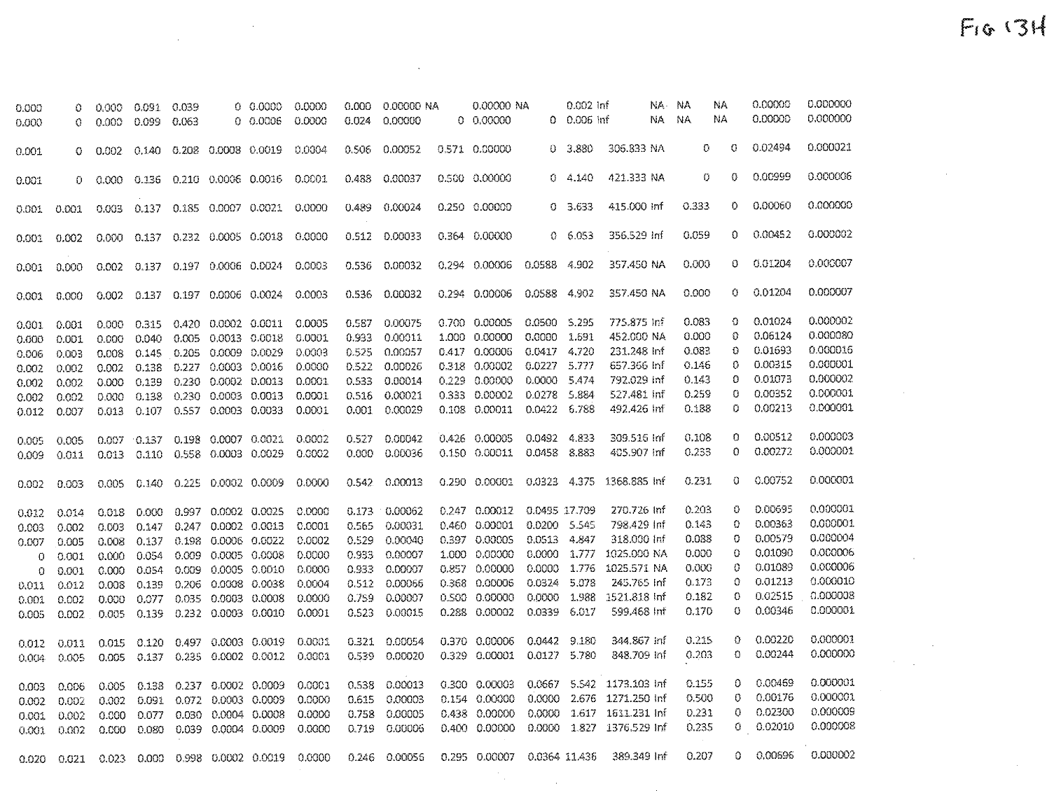

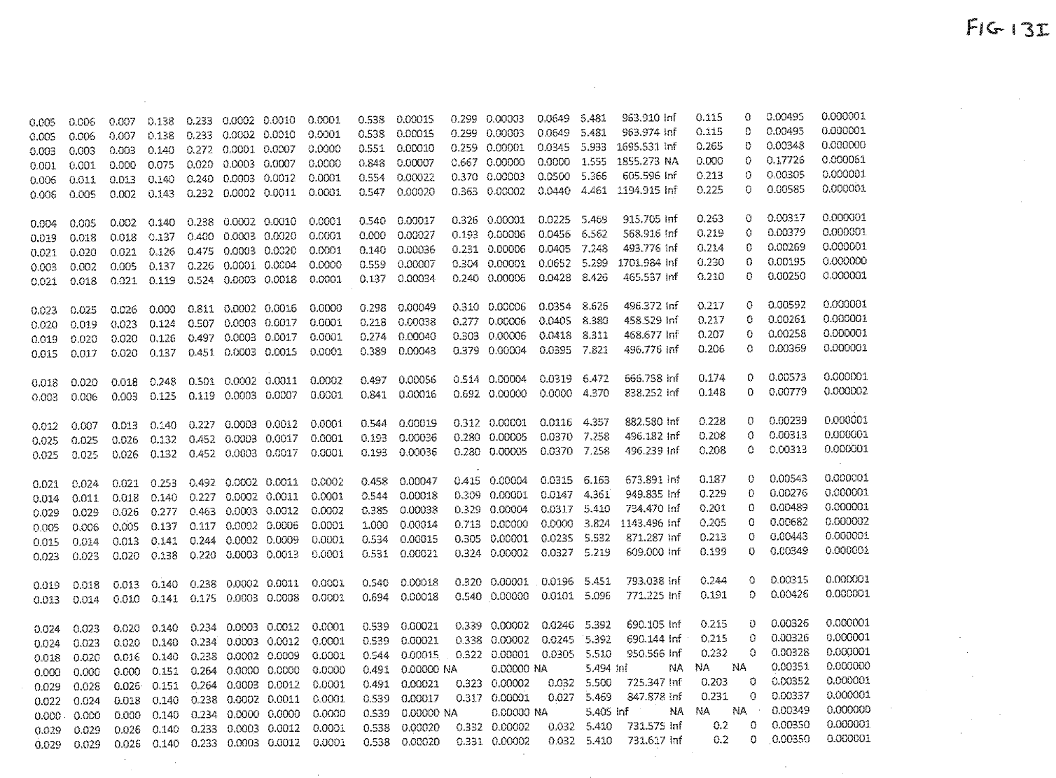

Of particular value is the specific analysis that compares, for various segments, the percentage (relative to all players/users) of time playing the game or using the service to the percentage (again, relative to the total) of purchase transactions for the specific type of transaction being evaluated and optimized. Such a comparison could, in the hypothetical case discussed above, yield a table as shown in FIGS. 13A-13I, which presents a subset of the kinds of data and categories that may be used by the subject invention to discover and implement segmentation strategies.

Potentially useful segments are listed in the first column 1302; various potential attributes of those segments are listed in the remaining columns. Thus segments analyzed include users who have purchased in-application goods in the last 3 days in row 1304; the control group for a specific pricewall protocol named “Global Test 1” in row 1306; one of the test groups for that test, called “Global Test Segment 3” is in row 1308; all users who have ever purchased in-application goods are in 1310; all members of the experimental segment “Pricing Group” who downloaded the game on the day the report was run are in row 1312; all user who downloaded the game on the day the report was run are in row 1314; all users in the Pricing Group who downloaded the game in the last 3 days are in row 1316; all users who downloaded the game on a Tuesday are in row 1318; all users who frequently play the game are in row 1320; users who play the game on a device with a high-resolution screen are in row 1322; all users in the control group who are outside the US are in row 1324; all users who play the game on devices that are very large mobile phones or small tablets (known as “phablets”) are in row 1326; players who visited the paywall for in-app purchases on the same day they downloaded the game are in row 1328; players who downloaded the game to medium-resolution devices are in row 1330; all users outside the US are in row 1332; and all users who have not yet purchased anything are in row 1334. The subject invention may be used to simultaneously evaluate hundreds or thousands of such segments, and a single user may of course be evaluated in multiple rows.

Additional columns in FIGS. 13A-13I present by row various attributes of the segments listed in the first column. Thus column 1336 shows the total number of users in each row; column 1338 shows the number of users in each row who viewed the payment wall at least once; column 1340 shows the number of users in each row who have made at least one in-game purchase; column 1342 shows the number of users in each row who have made multiple purchases; column 1344 shows the number of users in each row who are categorized as “minnows” (i.e., those who occasionally make small purchases); column 1346 shows the number of users in each row who are “dolphins” (defined as player who spend more than minnows); column 1348 shows the number of users in each row who are “whales” (big spenders, and thus very desirable customers); column 1350 shows the total spend associated with the users in each row; column 1352 shows the average revenue per user in that row; column 1354 shows the percentage of users in each row who were converted from users to paying users; column 1356 shows minnows within a row as a percentage of all users, which column 1358 shows the percentage of all minnows represented by the minnows in each row; column 1360 shows the percentage of users in each row who converted to paying users on the first day of play; column 1362 shows the percentage of all users that are represented by paying users in that row.

The knowledge gained in each of the previous steps is used in the next step in the subject invention, which is to generate new segmenting strategies, which can be analyzed along with the initial segmenting strategies that prove useful, thereby enabling the game or service provider to optimize pricing and other aspects of the user experience.

When a consumer downloads an application such as a game to a mobile device, the application will generally inform the consumer that, in order to use the service or game, the consumer will have to give permission to the game or service provider to perform operations that may include accessing data stored on the device.

The process of generating additional segmenting strategies leverages the wealth of facts and attributes that can be gathered regarding users of games or other services that are played or used on mobile devices. These factors may include:
The make and model of the device (or devices) used to play the game or use the service (e.g., Apple iPhone 5, Samsung Galaxy 5, etc.)
The primary service provider with which the user has a service contract (e.g., Verizon, Sprint, etc.)
Whether the user viewed an advertisement for the game or service, and if so which one(s)
Information regarding other games or product/services that have been downloaded on to the device
Information regarding which other games or products/service are currently in random access memory on the device (suggesting that they have recently been used)
The location of the device, both generally (i.e., which country) and more specifically (GPS coordinates, stationary or moving, location relative to the nearest cell tower, etc.)

Analysis will reveal that some of the segments are better at predicting the desired outcome than others. For example, for a game that demands powerful graphics processing, it may be that the segment of users with the latest mobile devices are much more likely to become paying users of the game than user whose devices are more than two years old. A game that simulates farming in a highly stylized manner may find few paying users in a geographic area where a large percentage of users are actually farmers.

However, there is a fundamental difference in terms of value to a game or service provider between characteristics that can be identified early in the interaction with the game provider (or even prior to that interaction) and those that emerge gradually over the course of a user's interaction with that game or service. For example, if it is the case that immutable characteristics, such as key attributes of the device used (screen size, processor speed) or the country where the device is sold or registered with a carrier reliably predict whether a user will be of high or low long-term value as a customer, that knowledge is likely to be of greater value than a predictor that is only observable after collecting a month's worth of data after a user has downloaded the game or service/application, such as actually observed intensity of use. A game provider may bring intuition to these questions, but the subject invention brings the ability to automate the process of discovering and acting upon those relationships.

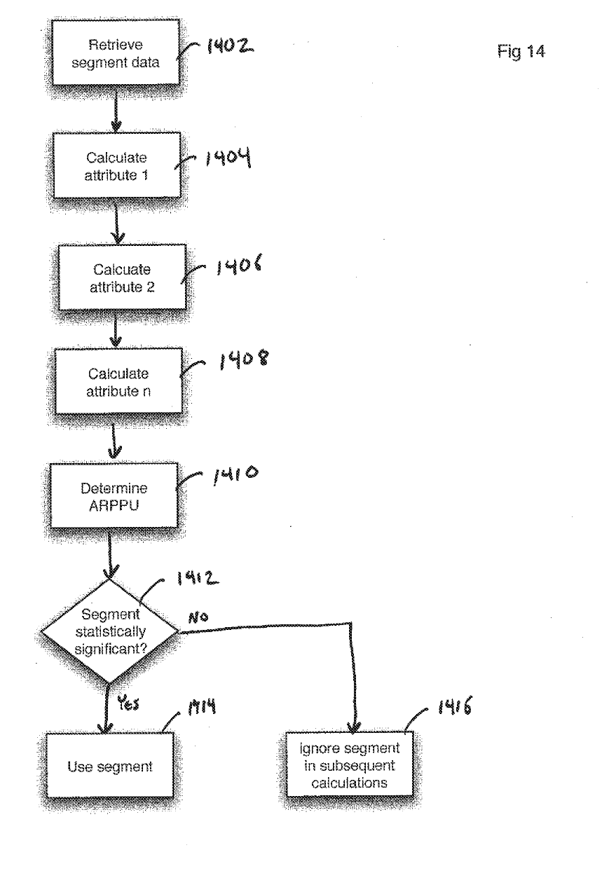

The subject invention can be used to evaluate whether each of these additional segmenting attributes is correlated with the desired outcome. A process for accomplishing this analysis is shown in FIG. 14.

In step 1402, the subject invention chooses a segment for evaluation. In step 1404, it applies the first of a series of tests to that segment. In the case of step 1404, it is to determine the percentage of members of that segment that became paying users of the game. In step 1406, the percentage of users who made multiple purchases is calculated. In step 1408 the average revenue per user (over a specific duration) is calculated for the segment. In step 1410 the average revenue per paying user is calculated for the segment. Additional or different tests may be applied.

Once the individual calculations for relevant metrics for a specific segment are complete, in step 1412 it is determined whether there is any statistical significance associated with the segment—in other words, whether grouping users according to the specific segmenting criteria yields any useful insights.

If the segment shows value in differentiating and predicting user behavior, then in step 1414 the segment is used in subsequent aspects of the invention as discussed below. If significance is not shown, then in step 1416 it is ignored.

In step 1418 the invention determines whether there are additional segments to be evaluated. If so, the process repeats; if not, in step 1420 it ends.

As discussed in FIG. 12, above, in addition to evaluating these segmenting factors individually, it is also possible and desirable to evaluate various combinations of these factors.

The subject invention can then combine the most useful segments from the original set of standard segmenting criteria with the most useful segmenting criteria from the extended set. For example the data may show that users who both downloaded and repeatedly play a given game on more than one up-to-date device, have at least five other similar games on their devices and live in certain zip codes in the United States are much more likely than the average user to make multiple purchases of in-game currency at the prices used in the default pay wall, whereas users who download the game to a single three-year old device and live in Spain are very unlikely to make even a single purchase regardless of how many other games they have downloaded.

One of the assumptions that the subject invention can effectively test is that players who do not make in-game purchases at a given pricing level can often be persuaded to do so at some lower price. Because the subject invention can successfully identify characteristics that are reasonably effective in predicting propensity to make such purchases, it can, as described in greater detail below, enable the game or other service to present lower prices to those with lower propensities to purchase, thereby adapting the product to local or even individual tastes and preferences.

Because the subject invention can predict with reasonable accuracy that this hypothetical game is, for example, unlikely to generate revenue from customers with older mobile devices in Spain, at least at price levels that work for many U.S. customers, it can automatically adapt to these insights and attempt to increase revenue from that segment by presenting different paywall options to that segment. For example, players on a latest-generation device with a billing address in Grosse Pointe, Mich. (characteristics that have been shown to indicate a high likelihood of in-game purchases) may see options of $0.99, $2.99 and $4.99 for different quantities of a virtual good, through learning, the subject invention may determine that revenue will be increased if the Spanish player with an older smart phone sees a paywall with options of €0.29, €0.99 and €1.99.

An example of a more involved application of the subject invention would be to improve yield by automatically applying multiple paywalls to multiple user segments initially separated by an external attribute such as perceived affluence by applying multi-armed bandit techniques and strategies.

The multi-armed bandit problem is derived from the context in which a gambler confronts several slot machines, and must decide how to allocate resources among them when the probability of a payout from each of the machines is unknown. The classic problem in such a context is that a player must tradeoff resources against two goals—exploration (learning about the payoff behavior of each machine) and exploitation (using the knowledge already gained to maximize results based on that limited knowledge). Multi-armed bandit techniques may be useful to a seller of goods or service when the characteristics and preferences and behavior of customers are hidden, or when some aspects of these are known, but their implications for the effect of changes in the seller's offerings are unknown.

As realized in the present invention, this approach involves dividing a population into multiple segments, applying different regimes to each segment, and measuring the results achieved, and using those results to modify subsequent test in multiple ways. While such techniques have been applied manually for many years, doing so in an automated fashion was not generally possible prior to the subject invention.

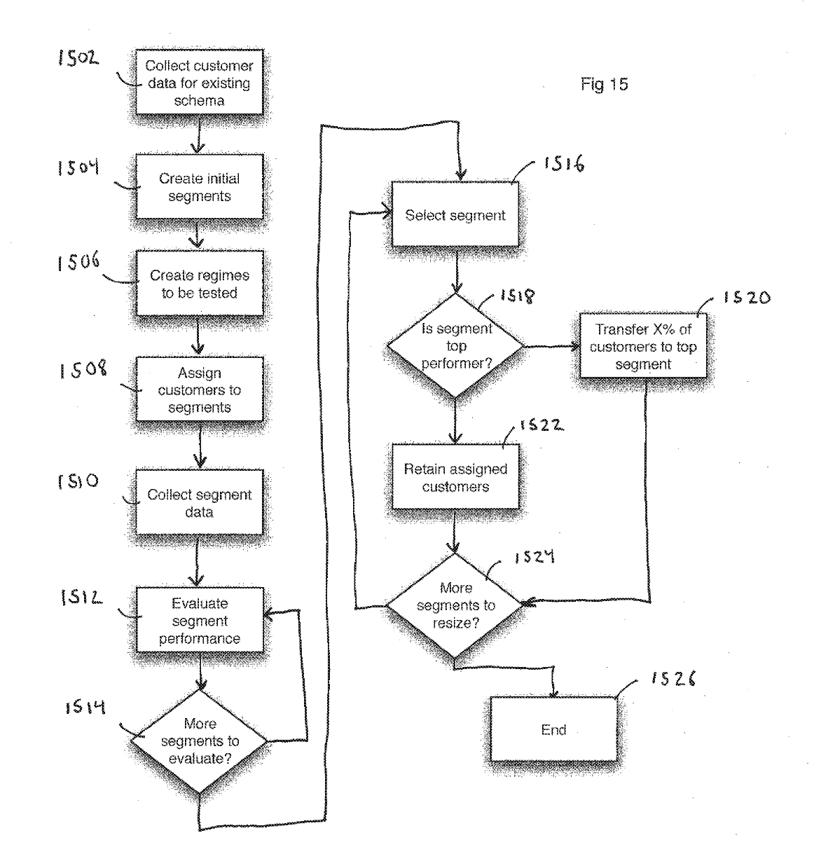

One method for employing the subject invention to quickly improve yield for a game, product or service already in use by customers is shown in FIG. 15. For purposes of this example, it may be assumed that the product for which yield is to be optimized is virtual currency used in a game for mobile devices, and it may be further assumed that this virtual currency has been offered to all users of the game in the same four-slot paywall. In step 1502 data is collected regarding the users of the game and their experiences in playing the game. As previously discussed, such data may include information about the device used, how often the user plays the game, etc. In step 1504, a segmenting schema is generated. Segmentation can be based on a variety of schemas. For some optimization processes it will make sense to create a control segment and multiple test segments, and to assign users randomly. In some case all users will be included in the protocol; in other cases the protocol will be limited to a subset of users. For example, it is likely to prove useful in many cases to limit the optimization exercise to the subset of users who have manifested strong affinity for the game, or to users who have been determined to be likely to have sufficient resources to be able to comfortably afford to spend money for discretionary purchases like virtual currency. (Indicators of that ability may include use of a new, high-end device.)

In step 1506, the proposed changes to the variable being optimized are generated. Thus in the case of a paywall in a game, a variety of alternate paywall values may be generated. In order to maximize the chances of generating valid results, it will often be advisable to include the status quo as a control as well as multiple test scenarios. In step 1508, users are placed into the previously generated segments. In order to maximize the reliability of the results of subsequent testing, it is important that such assignments are random, except to the extent that the population of users may be selected based upon characteristics that are common to that entire subset. However, there is latitude regarding the number of users assigned to each of the alternatives. If, for example, there is a high value placed on minimizing the chances that process will, even in its early stages, generate results that are inferior to those generated prior to implementation of this process, it may be advisable to initially assign a large number of users to the control group, and only begin moving them into one of the newly created test segments after it has been established that that regime performs better than the control regime.

Once the testing regime has been fully specified, it can be exposed to users for a first iteration of the test. In step 1510, data is collected regarding the performance of all of the segments. In step 1512 the performance of a given segment is evaluated. Thus it may be appropriate to determine the percentage of users who have made purchases, the average and/or mean purchase amount, the average and/or mean number of purchase transactions, etc. In step 1514 it is determined whether there are additional segments to be evaluated; if so, step 1512 is repeated; if not the invention proceeds to step 1516.

In step 1516 the performance of each segment in the first iteration of the test is selected in turn for ranking against the chosen metrics. In step 1518 it is determined whether the segment is the best performing segment. If the segment is not the top performer, then in step 1520 a subset of the users in that segment are reassigned to the top performing segment for the next iteration of the process. If the segment being evaluated is the top performing segment, then in step 1522 the users who were in that segment in the first iteration of test remain in that segment for the next iteration. In step 1524 it is determined whether there are additional segments to be resized; if so, steps 1516-1522 are repeated; of not, the process ends 1526.

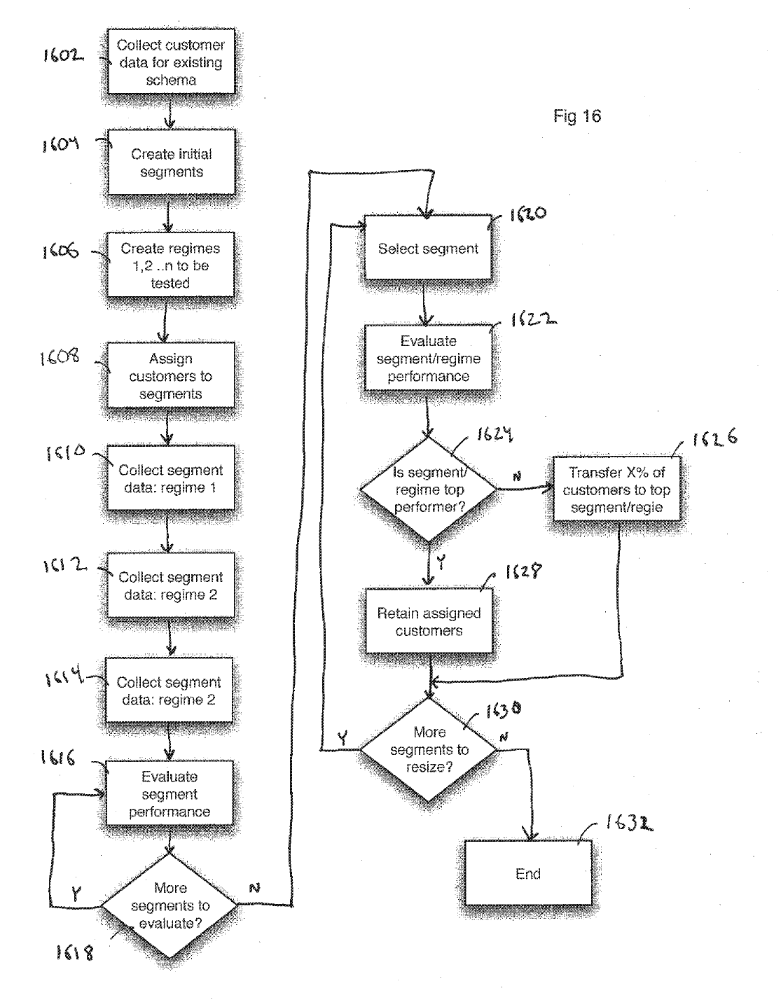

A variation on this approach may be applied when appropriate knowledge about the users of the game or other product or service for which yield is being optimized is available prior to the application of the subject invention. For example, if data is accessible that tends to correlate with the level of affluence of individual users (such as use of the newest high-end mobile device), it is possible to solve not only for the best pricing strategy for an entire population, but for appropriate pricing strategies for multiple strata within that population. One method for doing so is shown in FIG. 16.

For purposes of this example, it may be again assumed that the product for which yield is to be optimized is virtual currency used in a game for mobile devices, and it may be further assumed that this virtual currency has been offered to all users of the game in the same four-slot paywall. In step 1602 data is collected regarding the users of the game and their experiences in playing the game. As previously discussed, such data may include information about the device used, how often the user plays the game. In step 1604, that data is used to divide the population of users into segments based upon a characteristic that is believed to correlate with a behavioral characteristic that affects the variable against which yield is to be optimized. One example of such a characteristic is use of the most recent high-end mobile device, which may be assumed to correlate with affluence and thus ability to make in-application purchases (and to do so without aggressive price-cutting). Segments may also be created on the basis of the intersection of two or more criteria. As previously discussed, for some optimization processes it will make sense to create a control segment and multiple test segments. In all respects other than the explicit segmenting criteria employed, users should be randomly assigned to segments. In some case all users will be included in the protocol; in other cases the protocol will be limited to a subset of users. For example, it may prove useful in many cases to limit the optimization exercise to the subset of users who have manifested strong affinity for the game, or to users who have been determined to be likely to have sufficient resources to be able to comfortably afford to spend money for discretionary purchases like virtual currency.

In step 1606, the proposed changes to the variable being optimized are generated. Thus in the case of a paywall in a game, a variety of alternate paywall values may be generated. In order to maximize the chances of generating valid results, it will often be advisable to include the status quo as a control as well as multiple test scenarios. It may be advantageous to create multiple complete paywalls (paywall regime 1, regime 2 and so on through regime n), each of which may in turn be applied to each of the segments generated in step 1604. In step 1608, users are placed into the previously generated segments. In order to maximize the reliability of the results of subsequent testing, it is important that such assignments are random, except to the extent that the population of users may be selected based upon characteristics that are common to that entire subset. However, there is latitude regarding the number of users assigned to each of the alternatives. If, for example, there is a high value placed on minimizing the chances that the process will, even for brief periods in its early stages, generate results that are inferior to those generated prior to implementation of this process, it may be advisable to initially assign a large number of users to the control group, and only begin moving them into one of the newly created test segments after it has been established that that regime performs better than the control regime.

Once the testing regime has been fully specified, it can be exposed to users. In step 1610, data is collected regarding the performance of all of the segments under the first paywall regime to be tested. In step 1612, data is collected regarding the performance of all of the segments under the second paywall regime to be tested. Iteration continues until in step 1614, data is collected regarding the performance of all of the segments under the last paywall regime to be tested. While it is of course possible to apply the same regime to all segments simultaneously, that is not a requirement. Nor is it a requirement that all regimes be applied to all segments. It may be the case that, based upon a priori knowledge about a given segment, certain paywall regimes will be unlikely to produce improvements in yield for that segment. In such cases the process can be streamlined by omitting pairings that are unlikely to produce improvements.

In step 1616 the performance of a given segment is evaluated against each of the tested regimes. Thus it may be appropriate to determine the percentage of users who have made purchases, the average and/or mean purchase amount, the average and/or mean number of purchase transactions, etc. for each regime applied to that segment. In step 1618 it is determined whether there are additional segments to be evaluated; if so, step 1616 is repeated; if not the invention proceeds to step 1620.

In step 1620 the results for a specific segment are selected for analysis. In step 1622 the performance of each regime applied to the chosen segment in the first iteration of the test is determined. In step 1624 it is determined whether the regime/segment is the best performing segment. For each segment/regime that is not the top performer, in step 1626 a subset of the users in that segment/regime are reassigned to the top performing segment/regime for the next iteration of the process. If the segment/regime being evaluated is the top-performing segment/regime, then in step 1628 the users who were in that segment in the first iteration of test remain in that segment for the next iteration. In step 1630 it is determined whether there are additional segments to be resized; if so, steps 1620-1630 are repeated; of not, the process ends 1632.

The subject invention may be used to begin improving yield with minimal delay after initial use with applications such as mobile games. One such method involves evaluating a plurality of attributes of a plurality of existing users of said online game; using said plurality of attributes to divide said plurality of existing users into a plurality of segments; identifying at least a segment of said plurality of said users that is correlated with high performance in at least a category of user behavior relative to other subsets of users; identifying at least a segment of said plurality of said users that has previously been correlated with low performance in at least a category of user behavior relative to other subsets of users; setting a lower bound for a value presented in at least a slot of the paywall; downwardly adjusting at least said value in said slot in said paywall for said virtual goods presented to said segment of said plurality of said users that has previously been correlated with low performance; evaluating the performance of said segment of said plurality of said users that has previously been correlated with low performance by comparing its performance after said adjustment to the performance of said segment of said plurality of said users that is correlated with high performance; and continuing to adjust and compare as provided above until either (i) the performance of the segment of users that had previously been correlated with low performance is roughly equivalent to the performance of the segment correlated with high performance or (ii) said lower bound has been reached.

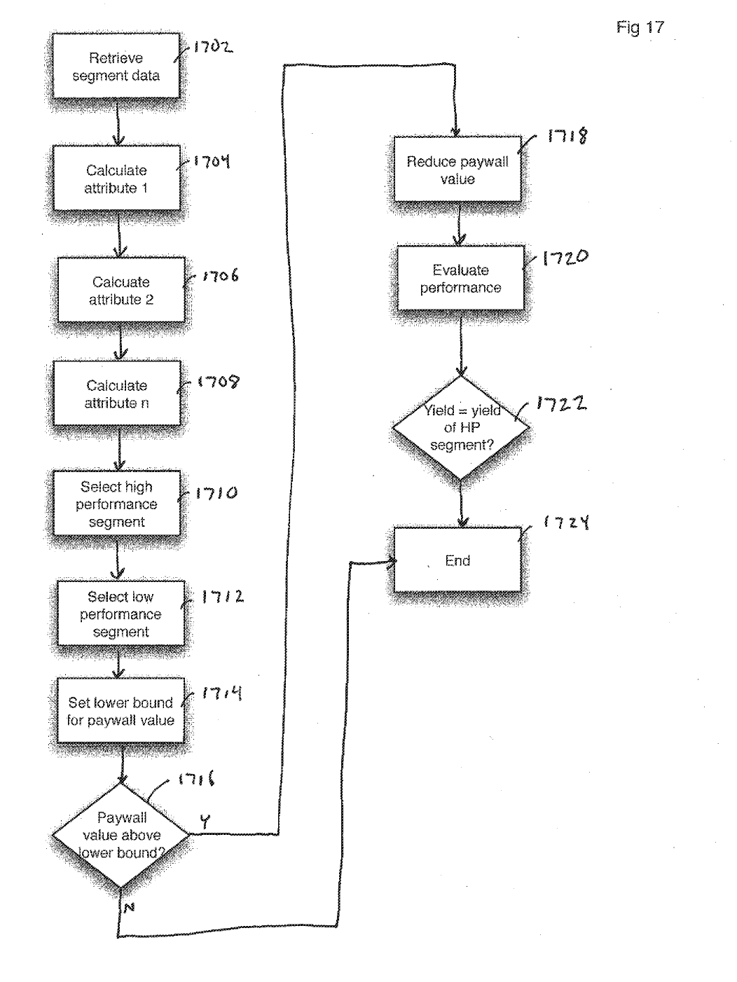

FIG. 17 illustrates the steps involved in one version of this method for using segmentation to improve yield. In step 1702 the subject invention retrieves segment data for the population(s) of users to be evaluated. In step 1704 the values for a specific attribute (for example, ARPU) for each segment are calculated. In step 1706 the values for another specific attribute (such as number of first day purchasers) are calculated. The process continues until in step 1708 the values for the final attribute (for example, the number of purchase transactions relative to the number of users in the segment) have been calculated. In step 1710, the values generated in the previous steps are used to determine the segment with the highest relative performance. This segment may be used in following steps as a baseline, and paywall values presented to users in other, lower performing segments will be adjusted in order to improve the performance of those segments. In essence, the subject invention operates on the assumption that a game or other intangible product will achieve better results with some segments than with others. However, it further assumes that these differences are not immutable, but are instead affected by multiple attributes, and that some of those attributes can be adjusted by the seller, such as prices. The subject invention can improve the performance of specific segments by intelligently and automatically altering those prices.

Thus having determined, that, for example, frequent game players with the most recent iPhone who live in the US produce the highest percentage of users who purchase in-game virtual currency among all segments, then in step 1712 the subject invention may identify an appropriate low-performance segment (for example, frequent players in Egypt) for which to perform optimization. In step 1714 the lower bound for reduced pricing is established—that is, the minimum pricing to be allowed for any user segment). In step 1716, it is determined whether the current paywall value is above the lower bound. If not, the routine will end for that segment. If it is still higher, then in step 1718 the price (or multiple prices) for the specific slot (or slots) of the paywall being optimized is reduced. Ideally, the reduction will not be a bare percentage reduction (e.g., drop by 10%), but will follow a process for maintaining psychologically friendly pricing. Thus for example if the lowest slot in the paywall for the US market was $1.99, and the lower bound was set at $0.49 (or local equivalent after foreign exchange conversion), and the segment being optimized is players on older Android devices in India, the value for the lowest slot in the paywall for those users may be reduced in the first iteration to 99 rupees (about $1.50 at current exchange rates).

After this change is made, the system will be permitted to run until sufficient data has been accumulated to determine the effect of the change. Ideally, this will include thousands of additional viewings of the altered paywall values by the users in the segment for which yield is being optimized. Once sufficient data has been collected, then in step 1720 the subject invention determines whether yield has improved. Yield is then compared in step 1724 to yield for the baseline segment. If yield has risen to match that of the baseline segment, then in step 1726 the process stops for that segment. If yield is still lower than for the baseline, then the paywall value is again lowered in step 1718. It may also be beneficial to determine whether yield has changed in the expected manner as a result of the change previously made. If for example, reducing prices has no effect, or of it appears to actually reduce yield, it will probably not be helpful to lower them further.

Once the lowest-performing segment has been optimized, the process may be repeated with the “new” lowest performing segment, and so on.

It should also be noted that lowering values in the paywall will not always be the appropriate change for a given segment. While lower values will generally increase the number of transactions, they may not increase revenue. For segments that are relatively price-insensitive, raising paywall values may increase revenue by boosting per-transaction revenue without materially reducing the number of purchase transactions. The subject invention will be highly effective in automatically optimizing for this context as well.

It should also be noted that presenting shifting prices to individual users will in many cases be counter-productive. If a user notices frequent changes, the user will likely come to consciously adapt her behavior to that context, and “wait for the next sale” before making purchases. It may therefore be advantageous to apply the price changes discussed herein only to segment members who have not been presented with the pre-adjustment paywall (most likely because the users have not visited the paywall since the instantiation of the process) in the recent past. Where the number of users is sufficiently large, this approach will not materially reduce the efficacy of the process.

In addition to using collected data to predict how different groups of users will react to different paywalls in terms of overall propensity to purchase, the subject invention may be used to optimize performance of different choices within a given paywall.

When presented with multiple price/quantity options for a single purchase, consumers generally may be thought of as making not one but two distinct purchasing decisions. For example, when a player is presented with four different virtual gold coin bundles in a paywall, the player will generally first decide whether to purchase at all. That initial decision is likely to be driven by a determination as to whether any of the presented prices is “low enough.” This requirement will likely drive a game or service provider to offer at least one purchasing option that requires minimal cash outlay.

However, one of the valuable functions of a paywall with multiple options is to encourage customers make choices other than the lowest price option. This function is brought into play during the second phase of the consumer's decision-making process. In this phase, the consumer, having already decided to buy, decides which option presents the “best deal.” The relative price levels within the paywall heavily influence the consumer's decision-making process. If a one-dollar purchase buys one widget, and a $100 purchase buys 99 of them, most consumers will view the quantity discount as inadequate, and if those are the only choices, the paywall will probably lead to lots of one-dollar purchases. If one dollar buys one widget, but two dollars buys ten of them, significant numbers of consumers will pay two dollars, because the discount is very high, and the “best deal” is the larger purchase.

However, it will not always be the case that discounting in order to increase the dollar value of a transaction is preferable. While maximizing transaction size is usually the best short-term tactic, many game vendors and providers of other virtual goods and service may prefer to optimize for other measures, such as lifetime value (LTV). Thus in the case of a game that cultivates long-term play, it may be useful to detect the difference between a user who is likely to continue to play and make purchases on the one hand, and one who is likely to churn (stop playing). Giving the former a large discount for a bigger currency purchase may reduce LTV—that customer will produce greater value for the seller by making a series of smaller purchases at higher unit prices. The customer who appears likely to stop playing, on the other hand, should be encouraged to spend as much as possible before leaving.

It may also be useful for the provider of a game or other virtual good to take into account whether “wealth effects” are associated with purchases of the good in question. Thus, for example, understanding whether having a “fat wallet” makes players of a virtual slot machine game spend more virtual currency should inform the decision to discount bulk purchases. It is likely that the more pronounced such wealth effects are for a given game and segment, the more aggressive the quantity discounts should be.

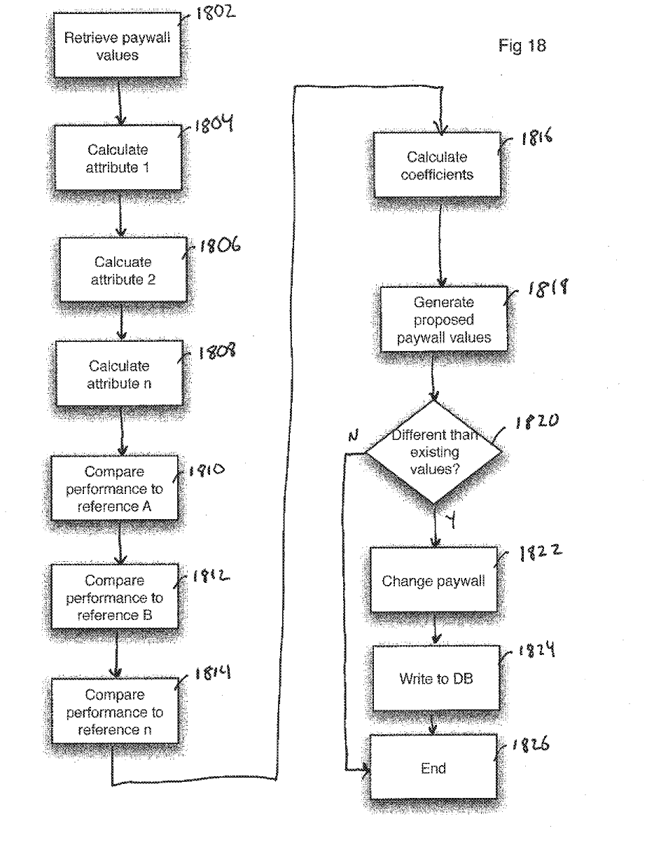

The subject invention is capable of acting automatically upon these insights in several ways. For example, if an online game determines that players with very large caches of virtual currency play a game less frequently, the subject invention can detect that pattern, and can reduce the quantities of goods offered on the paywall, or reduce the discount rate for large purchases, or both. Similarly, if the subject invention determines a high level of intensity in play by a given player or segment of players, as evidenced by frequent purchase transactions, it can reduce the discounting provided for larger bundles. FIG. 18 presents a flowchart illustrating the steps involved in automatically adjusting a paywall to account for such differences.

In step 1802, the process retrieves the existing paywall values (prices and quantities). It then calculates the performance of the paywall in terms of a series of relevant performance criteria. Thus in step 1804, it calculates a first attribute, which could be the percentage of players who view the paywall and go on to make a purchase. In step 1806 it calculates a second attribute, which could be the percentage of players who choose each of the four slots in the paywall. In step 1808 it calculates the last of what could be a large number of attributes.

Next the process compares the previously calculated values to the values associated with a series of references in order to determine whether the paywall values should be changed (and how they should be changed), which requires that the performance of the paywall be compared to at least a baseline. Thus in step 1810 it compares the performance of the paywall to a first reference, which may be previously used paywall values for the same game. In step 1812 it compares the performance of the paywall to a second reference, which may be a composite of current paywalls employed by the game provider in its best performing games. In step 1814 it performs the last of what could be a large number of such comparisons. Additional or different comparisons may be performed.

In step 1816 the mathematical relationships between the paywall under test and the baseline paywalls are determined. In step 1818, the subject invention generates suggested paywall values based on the foregoing steps. This may be accomplished using a process similar to that shown in FIG. 15, or may use other processes. In step 1820, the generated paywall values are compared to the existing paywall values. If they differ, then in step 1822 the new values are passed forward for use in an updated paywall, and written to a database or other long-term memory in step 1824. If the values are unchanged (which becomes more likely for a mature game with a stable user base), then in step 1826 the process ends.

In addition to using machine learning as discussed above to manage pricing of virtual and other digital goods, the subject invention may be used to improve a variety of aspects of the user experience. For example, simply altering prices in a paywall at the time at which a player naturally chooses to view it may not convey all of the pricing-related information the game provider wishes to convey. If, for example, the player is being offered a discount for a reason the player may find flattering (e.g., because the player has reached a certain skill level), that discount is more likely to achieve the desired result if the player is appropriately informed of that reason. Thus sending that player a message (via email, IM or in-game message) alerting her to that reward is likely to increase the chances that the player will respond as desired. Alternatively, segment analysis may suggest that a flash sale at a specific local time is likely to persuade certain low-engagement users to make purchases. Again, because the player is unlikely to visit the paywall unprompted, a separate message alerting him to the discount is likely to be helpful.

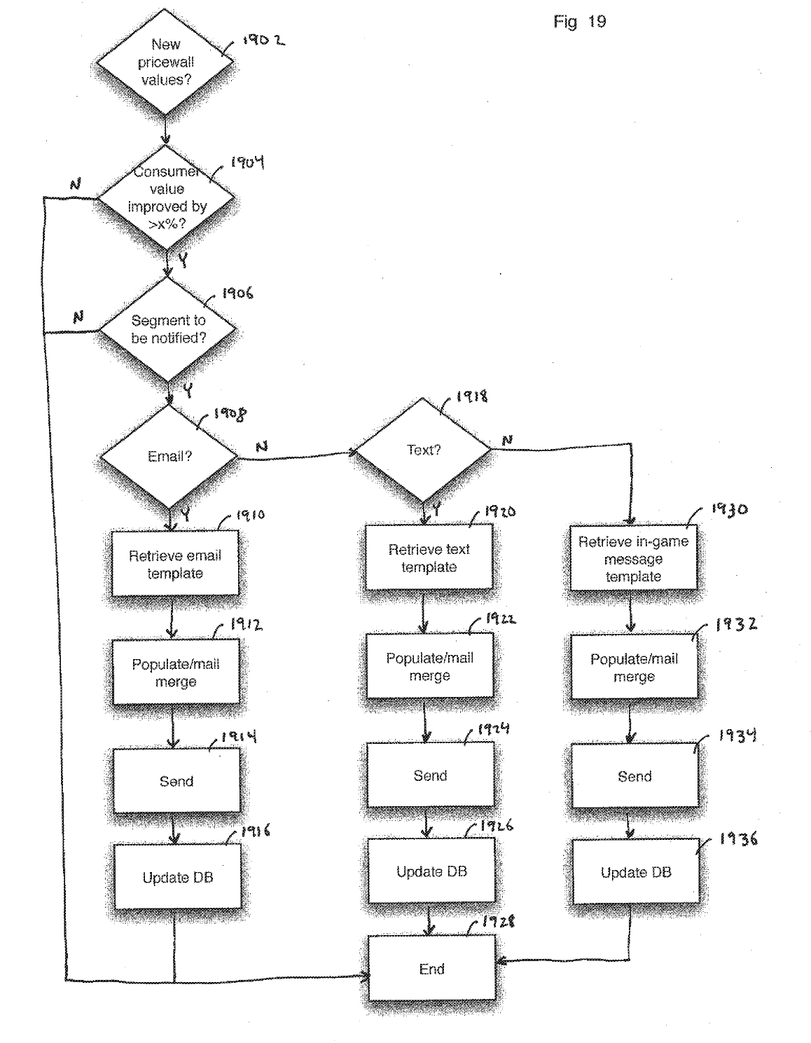

FIG. 19 illustrates the steps used in one example of a process to deliver such messaging, in which changes to paywall values instantiated by the process described in FIG. 18 may trigger such messaging.

In step 1902 new pricewall values are fed to this process. In step 1904, it is determined whether the new pricewall values are sufficiently different from the old values to merit sending messages to one or more user segments. It will likely not be effective to send messages to most users if the price reduction is relatively small, both because small changes are unlikely to motivate changes in purchasing patterns, and because frequent messaging is likely to annoy players and thus be counterproductive. Thus if the change is small, the process ends 1936. If the change is large enough, the process determines whether a specific segment of users is to be notified 1906. It will likely be useful to prioritize giving notice to certain users, such as those that are believed to be more price-sensitive, or those may be manifesting behavior (such as reduced play time or longer intervals between sessions) that indicates that they are at risk for churning out of the game. If a given group is not to be notified, then in step 1936 the process ends. If a group is to be notified, then in step 1908 it is determined whether email notification is to be given. If email notification is to be sent, then in step 1910 the proper email template is retrieved, and in step 1912 the template is merged with the customer-specific and offer-specific information required. In step 1914 the merged emails are sent, and in step 1916 the database or other long-term memory means is updated to reflect that fact, and in step 1936 the process ends.

If email is not the chosen method for contacting users, then in step 1918 it is determined whether to employ an alternate method such as text messaging. If texting is to be used, then in step 1920 the template for the text message is retrieved. In step 1922 the template is merged with the customer-specific and offer-specific information required. In step 1924 the merged text messages are sent, and in step 1926 the database or other long-term memory means is updated to reflect that fact, and in step 1936 the process ends.

If texting is not be used, and there is a method for sending messages within the environment of the game or other product, then in step 1928 the template for the in-application message is retrieved. In step 1930 the template is merged with the customer-specific and offer-specific information required. In step 1932 the merged in-app messages are sent, and in step 1934 the database or other long-term memory means is updated to reflect that fact, and in step 1936 the process ends.

The subject invention may also be used to adapt aspects of user experience, such as parameters affecting game play, based on segmenting as described above. For example, it is well known in the gaming industry that successful games are neither too easy nor too hard. This knowledge is usually applied globally, and managed by presenting the game as a series of levels, and only allowing a player to progress to Level 2 after mastering Level 1, etc. But if Level 1 is made easy enough for players of all levels of sophistication (and made compatible with even the oldest devices), it may turn off advanced players, who may quickly move on to a different game that offers greater challenges; if Level 1 is made too difficult, other players will turn away. Similar dynamics can affect a myriad of choices about many other aspects of game play.

Rather than present a one-size-fits-all game experience, a game provider can employ the subject invention to parameterize various decisions about game parameters, learn which settings result in higher playing intensity, stickiness, etc. for different segments, and present optimized game parameters based on the needs and abilities of different players.

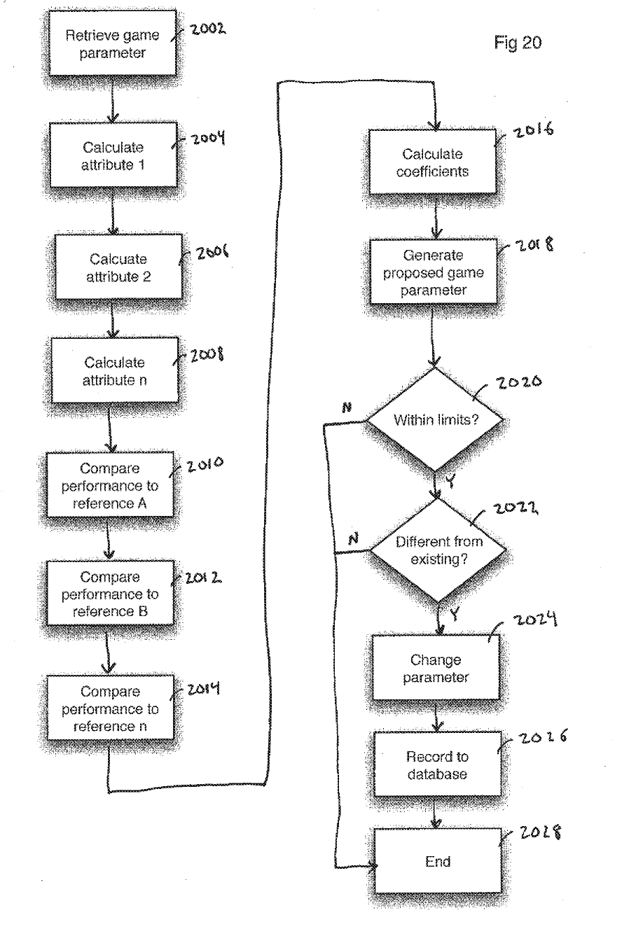

FIG. 20 illustrates the steps in one process that could be used to optimize in-game parameters.

In step 2002, the process retrieves the existing game parameter to be optimized. Such parameters can include a wide range of factors: the speed with which objects or opponents move, the amount of damage a player can absorb, the odds of a given consequence for a player-initiated action, etc. It then calculates the performance of the game in terms of a series of relevant performance criteria. Thus in step 2004, it calculates a first attribute, which could be the percentage of players who view the paywall and go on to make a purchase. In step 2006 it calculates a second attribute, which could be the percentage of players who choose each of the four slots in the paywall. In step 2008 it calculates the last of what could be a large number of attributes.

Next the process compares the previously calculated values to the values associated with a series of references in order to determine whether the game parameter should be changed (and how it should be changed), which requires that the performance of the game with the given segment be compared to at least a baseline. Thus In step 2010 it may compare the performance of the game to its performance with previously used values for the same parameter with the same segment. In step 2012 it may compare the performance of the game with the current segment to a composite of the best performing segments for the same game. In step 2014 it performs the last of what could be a large number of comparisons. Additional or different comparisons may be performed.

In step 2016 the mathematical relationships between the game parameter under test and the alternate values for that parameter are determined. Thus it may be the case that the segment being evaluated had 23% more purchase transactions per user when the setting for an aspect of player “health” was lower than its current setting. In step 2018, the subject invention generates suggested parameter values based on the foregoing steps. In step 2020, the generated parameter values are compared to limits placed on those values. It is assumed that in general game providers will want to establish limits beyond which automated adjustments are not permitted. If the proposed change is not within limits, then in step 2028 the routine ends. If the proposed change is within limits, then in step 2022 the generated parameter values are compared to the existing parameter values. If they differ, then in step 2024 the new values are passed forward for use in the game by users within the segment. If the values are unchanged (which becomes more likely for a mature game with a stable user base), then in step 2028 the process ends. If the values have been changed, then in step 2026 the change is recorded in a database.

What is claimed is:

1. A method for automatically adjusting values for the costs of virtual goods offered within an online game played on a mobile device such as a smart phone as presented in a multi-slot pay wall or a targeted offer, comprising:
evaluating a plurality of attributes of a plurality of existing users of said online game;
using said plurality of attributes to divide said plurality of existing users into a plurality of segments;
assigning different pay wall values to each of the plurality of segments;
identifying at least a segment of said plurality of said users that is correlated with high performance in at least a category of user behavior relative to other subsets of users;
identifying at least a segment of said plurality of said users that has previously been correlated with low performance in at least a category of user behavior relative to other subsets of users; and
moving at least a user from said segment of said plurality of said users that has previously been correlated with low performance in at least a category of user behavior relative to other subsets of users to said segment of said plurality of said users that is correlated with high performance in at least a category of user behavior relative to other subsets of users.

2. A method as in claim 1 in which said attributes include the make and model of at least a device used to play the game.

3. A method as in claim 1 in which said attributes include at least one of the country where the device used to play the game is located and the specific location of the device used to play the game as determined by geolocation system such as GPS coordinates, or by triangulation from the nearest cell phone towers.

4. A method as in claim 1 in which said attributes include at least one of the total quantity of time a user has played said game, the amount of time per day a user has played said game, the length of each session when a user plays said game, whether a player has visited at least a pay wall in said game, and the amount of virtual goods used by a user.

5. A method as in claim 1 in which said attributes include the primary cellular service provider with which the user has a service contract for the device used to play the game

6. A method as in claim 1 in which said attributes include the amount of virtual currency held by said players.

7. A method as in claim 1 in which at least one of said segments of said plurality of users is limited to users who have manifested affinity for said game through actions including prior viewing of at least a paywall in said game.

8. A method as in claim 1 in which at least one aspect of performance of said users is the percentage of said users who have made purchases of said virtual goods.

9. A method as in claim 1 in which at least one aspect of performance of said users is the amount of said virtual goods purchased by said users who have made purchases of said virtual goods.

10. A method as in claim 1 in which at least one aspect of performance of said users is the frequency with which said users play said game.

11. A system for automatically adjusting values for the costs of virtual goods offered within an online game played on a mobile device such as a smart phone as presented in a multi-slot pay wall or a targeted offer, said system comprising:
computer memory that stores a plurality of computer instructions;
one or more computer processors in communication with the computer memory, the one or more computer processors configured to execute the plurality of instructions to:
evaluate a plurality of attributes of a plurality of existing users of said online game;
use said plurality of attributes to divide said plurality of existing users into a plurality of segments;
assign different pay wall values to each of the plurality of segments;
identify at least a segment of said plurality of said users that is correlated with high performance in at least a category of user behavior relative to other subsets of users;
identify at least a segment of said plurality of said users that has previously been correlated with low performance in at least a category of user behavior relative to other subsets of users; and
move at least a user from said segment of said plurality of said users that has previously been correlated with low performance in at least a category of user behavior relative to other subsets of users to said segment of said plurality of said users that is correlated with high performance in at least a category of user behavior relative to other subsets of users.

12. A system as in claim 11 in which said attributes include the make and model of at least a device used to play the game.

13. A system as in claim 11 in which said attributes include at least one of the country where the device used to play the game is located and the specific location of the device used to play the game as determined by geolocation system such as GPS coordinates, or by triangulation from the nearest cell phone towers.

14. A system as in claim 11 in which said attributes include at least one of the total quantity of time a user has played said game, the amount of time per day a user has played said game, the length of each session when a user plays said game, whether a player has visited at least a pay wall in said game, and the amount of virtual goods used by a user.

15. A system as in claim 11 in which said attributes include the primary cellular service provider with which the user has a service contract for the device used to play the game.

16. A system as in claim 11 in which said attributes include the amount of virtual currency held by said players.

17. A system as in claim 11 in which at least one of said segments of said plurality of users is limited to users who have manifested affinity for said game through actions including prior viewing of at least a pay wall in said game.

18. A system as in claim 11 in which at least one aspect of performance of said users is the percentage of said users who have made purchases of said virtual goods.

19. A system as in claim 11 in which at least one aspect of performance of said users is the amount of said virtual goods purchased by said users who have made purchases of said virtual goods.

20. A system as in claim 11 in which at least one aspect of performance of said users is the frequency with which said users play said game.
